(19) United States
(12) Patent Application Publication
(10) Pub. No.: US 2025/0018350 A1
(43) Pub. Date: Jan. 16, 2025

(54) AIR-PERMEABLE FILTER AND AIR-PERMEABLE MEMBER

(71) Applicant: NITTO DENKO CORPORATION, Osaka (JP)

(72) Inventors: Kodai UEDA, Osaka (JP); Yu KAMAMOTO, Osaka (JP); Yuichi TAKAMURA, Osaka (JP); Satoru FURUYAMA, Osaka (JP)

(73) Assignee: NITTO DENKO CORPORATION, Osaka (JP)

(21) Appl. No.: 18/709,940

(22) PCT Filed: Nov. 8, 2022
(86) PCT No.: PCT/JP2022/041593

§ 371 Date: May 14, 2024

(30) Foreign Application Priority Data
Nov. 18, 2021 (JP) 2021-188186

(51) Int. Cl. B01D 71/32; B01D 71/52

(52) U.S. Cl. CPC B01D 71/32; B01D 71/52; B01D 2239/1258; B01D 2325/02833; B01D 2325/02834

(57) ABSTRACT

An air-permeable filter includes a porous fluorine resin membrane having one principal surface and the other principal surface, and treated with an oil-repellent agent for oil-repellency. In a measurement of its absorption spectrum by Fourier-transform infrared spectroscopy, an absorbance ratio R_{f} of the one principal surface and an absorbance ratio R_{b} of the other principal surface calculated by Aₐ/Aₘ are not substantially the same. The Aₐ indicates an absorbance at a peak derived from the oil-repellent agent in the absorption spectrum, and the Aₘ indicates an absorbance at a peak derived from a C—F bond in the absorption spectrum.

### TECHNICAL FIELD

The present invention relates to an air-permeable filter imparted with oil repellency, and an air-permeable member.

### BACKGROUND ART

An air-permeable filter may be attached to a housing of an electrical component or the like for the purpose of ensuring air permeability between inside and outside of the housing, thereby adjusting the internal pressure of the housing. Some such air-permeable filters have porous fluorine resin membranes. An example of the porous fluorine resin membrane is a porous polytetrafluoroethylene (hereinafter, referred to as “PTFE”) membrane. With this type of air-permeable filter, entry of foreign matters such as water and dust into the housing from the outside can be more reliably prevented due to the excellent water resistance and dustproof properties of the porous fluorine resin membrane. The housing is, for instance, a housing of an electrical component such as smart watch or mobile phone.

Though the porous fluorine resin membrane has high water resistance, it may allow liquids with low surface tension, such as hydrocarbons like kerosene and diesel oil, a low molecular weight alcohol and a surfactant, to pass through. Therefore, in such applications, the porous fluorine resin membrane is subjected to an oil-repellent treatment using an oil-repellent agent.

For instance, Patent Literature 1 describes that an oil-repellent air-permeable filter is obtained by a so-called soaking method in which a porous PTFE membrane configuring an air-permeable filter is soaked in an oil-repellent treatment liquid. In Example of Patent Literature 1, a porous PTFE membrane with an average pore diameter of 1 μm is used.

### CITATION LIST

### Patent Literature

[Patent Literature 1] JP 2012-236188, A

### SUMMARY OF INVENTION

### Technical Problem

Particularly when an oil-repellent agent is supplied sufficiently for the purpose of obtaining a favorable oil repellency, pores of the porous fluorine resin membrane configuring the air-permeable filter may get clogged, thereby declining its air permeability. For this reason, according to a conventional technique, a porous fluorine resin membrane with a relatively large pore diameter is subjected to an oil-repellent treatment in order to maintain high air permeability. However, depending on the application or required properties of the air-permeable filter, use of a porous fluorine resin membrane with a small pore diameter may be required.

Therefore, the present invention aims to provide an air-permeable filter that is suitable for preventing or reducing decline in air permeability while exhibiting oil repellency, regardless of the pore diameter of the porous fluorine resin membrane.

### Solution to Problem

As a result of extensive researches, the present inventors have found that the aforementioned objective can be achieved by controlling distribution of the oil-repellent agent in the porous fluorine resin membrane. In a conventional technique, an excess amount of oil-repellent agent is supplied to a principal surface to be imparted with oil repellency, and the amount is more than the required amount, not only in a case of employing a soaking method of supplying the oil-repellent agent from both the surfaces, but also in a case of a coating method of supplying the oil-repellent agent from only one of the principal surfaces. According to the study by the present inventors, in such a case, the amount of oil-repellent agent present on both principal surfaces will be substantially the same.

The present invention provides an air-permeable filter including a porous fluorine resin membrane having one principal surface and the other principal surface, the porous fluorine resin membrane being treated with an oil-repellent agent, wherein

in a measurement of an absorption spectrum of the air-permeable filter by Fourier transform infrared spectroscopy, an absorbance ratio R_{f} of the one principal surface and an absorbance ratio R_{b} of the other principal surface calculated by Formula (1) below are not substantially the same:

Aₐ/Aₘ Formula (1),

where Aₐ indicates an absorbance at a peak derived from the oil-repellent agent in the absorption spectrum, and Aₘ indicates an absorbance at a peak derived from a C—F bond in the absorption spectrum.

From another aspect, the present invention provides an air-permeable member including:

the air-permeable filter of the present invention; and

a pressure-sensitive adhesive layer bonded to the air-permeable filter.

### Advantageous Effects of Invention

The present invention can provide an air-permeable filter suitable for preventing or reducing a decline in air permeability while exhibiting oil repellency, regardless of the pore diameter of the porous fluorine resin membrane.

### BRIEF DESCRIPTION OF DRAWINGS

FIG. 1 is a cross-sectional view schematically showing an example of air-permeable filter of the present invention.

FIG. 2 is a cross-sectional view schematically showing an example of distribution state of an oil-repellent agent in an air-permeable filter of the present invention.

FIG. 3A is a perspective view schematically showing another example of air-permeable filter of the present invention.

FIG. 3B is a cross-sectional view of the air-permeable filter shown in FIG. 3A.

FIG. 4A is a perspective view showing an example of air-permeable member of the present invention.

FIG. 4B is a cross-sectional view of the air-permeable member shown in FIG. 4A.

FIG. 5A is a perspective view showing another example of air-permeable member of the present invention.

FIG. 5B is a cross-sectional view of the air-permeable member shown in FIG. 5A.

FIG. 6A is a cross-sectional view schematically showing an example in which an air-permeable member of the present invention is attached to an opening in a housing of an electronic device or the like or an opening in an electronic component.

FIG. 6B is a cross-sectional view schematically showing another example in which an air-permeable member of the present invention is attached to an opening in a housing of an electronic device or the like or an opening in an electronic component.

FIG. 6C is a cross-sectional view schematically showing still another example in which an air-permeable member of the present invention is attached to an opening in a housing of an electronic device or the like or an opening in an electronic component.

FIG. 7A is a schematic cross-sectional view for explaining an absorption spectrum measurement by FT-IR relative to an air-permeable filter of the present invention.

FIG. 7B is a graph showing an example of an absorption spectrum by FT-IR relative to an air-permeable filter of the present invention.

FIG. 7C is a graph showing another example of an absorption spectrum by FT-IR relative to an air-permeable filter of the present invention.

FIG. 8 is a graph showing absorbance ratios in a thickness direction of an air-permeable filter in Example 1.

FIG. 9 is a graph showing absorbance ratios in a thickness direction of an air-permeable filter in Example 2.

FIG. 10 is a graph showing absorbance ratios in a thickness direction of an air-permeable filter in Example 3.

FIG. 11 is a graph showing absorbance ratios in a thickness direction of an air-permeable filter in Example 4.

FIG. 12 is a graph showing absorbance ratios in a thickness direction of an air-permeable filter in Example 5.

FIG. 13 is a graph showing absorbance ratios in a thickness direction of an air-permeable filter in Example 6.

FIG. 14 is a graph showing absorbance ratios in a thickness direction of an air-permeable filter in Example 7.

FIG. 15 is a graph showing absorbance ratios in a thickness direction of an air-permeable filter in Example 8.

FIG. 16 is a graph showing absorbance ratios in a thickness direction of an air-permeable filter in Example 9.

FIG. 17 is a graph showing absorbance ratios in a thickness direction of an air-permeable filter in Example 10.

FIG. 18 is a graph showing absorbance ratios in a thickness direction of an air-permeable filter in Example 11.

FIG. 19 is a graph showing absorbance ratios in a thickness direction of an air-permeable filter in Example 12.

FIG. 20 is a graph showing absorbance ratios in a thickness direction of an air-permeable filter in Example 13.

FIG. 21 is a graph showing absorbance ratios in a thickness direction of an air-permeable filter in Example 14.

FIG. 22 is a graph showing absorbance ratios in a thickness direction of an air-permeable filter in Example 15.

FIG. 23 is a graph showing absorbance ratios in a thickness direction of an air-permeable filter in Example 16.

FIG. 24 is a graph showing absorbance ratios on both principal surfaces of an air-permeable filter in Comparative Example 1 (measurement of membrane center is omitted).

FIG. 25 is a graph showing absorbance ratios on both principal surfaces of an air-permeable filter in Comparative Example 2 (measurement of membrane center is omitted).

FIG. 26 is a graph showing absorbance ratios on both principal surfaces of an air-permeable filter in Comparative Example 3 (measurement of membrane center is omitted).

FIG. 27 is a graph showing absorbance ratios in a thickness direction of an air-permeable filter in Example 17.

FIG. 28 is a graph showing absorbance ratios in a thickness direction of an air-permeable filter in Example 18.

FIG. 29 is a graph showing absorbance ratios in a thickness direction of an air-permeable filter in Example 19.

FIG. 30 is a graph showing absorbance ratios in a thickness direction of an air-permeable filter in Example 20.

### DESCRIPTION OF EMBODIMENTS

Hereinafter, embodiments of the present invention will be explained with reference to the attached drawings. The present invention is not limited to the following embodiments.

### [Air-Permeable Filter]

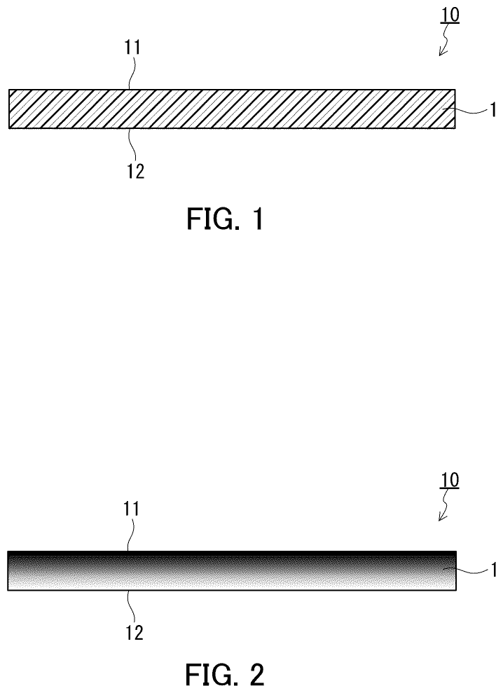

An example of air-permeable filter of the present embodiment is shown in FIG. 1. An air-permeable filter 10 in FIG. 1 includes a porous fluorine resin membrane 1 having one principal surface 11 and the other principal surface 12. The porous fluorine resin membrane 1 has oil-repellency imparted by a treatment with an oil-repellent agent.

When an absorption spectrum of the air-permeable filter 10 is measured using ATR (Attenuated Total Reflection) method of Fourier-transform infrared spectroscopy (hereinafter referred to as “FT-IR”), an absorbance ratio R_{f} of the one principal surface 11 and an absorbance ratio R_{b} the other principal surface 12 are not substantially the same. The ATR method is a method to obtain an absorption spectrum of a sample surface by measuring infrared light that is totally reflected on the surface of the sample. The measurement depth by the ATR method is approximately 1 μm. Both the absorbance ratio R_{f} and the absorbance ratio R_{b} are calculated by Formula (1) below.

$${A}_{a} / {A}_{m} \qquad Formula ( 1 )$$

In Formula (1), the Aₐ indicates an absorbance at a peak derived from the oil-repellent agent in the absorption spectrum, and the Aₘ indicates an absorbance at a peak derived from a C—F bond in the absorption spectrum.

In the present embodiment, when the absorbance ratio R_{f} and the absorbance ratio R_{b} are “substantially the same”, it means that these ratios are considered as equivalent even if there is a slight difference caused by measurement accuracy or the like. The slight difference in the absorbance ratios caused by measurement accuracy or the like is about 0.002, or even about 0.0015, for instance. In other words, in the present embodiment, the absorbance ratio R_{f} and the absorbance ratio R_{b} being “substantially the same” means that the difference in the absorbance ratio is 0.0015 or less, or more specifically 0.001 or less.

The peak derived from the C—F bond is present near the wavenumber of 1150 cm⁻¹ in the above absorption spectrum. This peak is known to be caused by stretching vibration of the C—F bond. The peak derived from the C—F bond reflects the amount of fluorine resin as well as the oil-repellent agent, and usually most of the peak is derived from the fluorine resin.

The peak derived from the oil-repellent agent is a peak derived from a bond other than the C—F bond. The peak derived from the oil-repellent agent is, for instance, a peak derived not from a fluorine resin but an oil-repellent agent, i.e., a peak derived from only the oil-repellent agent, and specifically, it may be a peak derived from a bond other than a C—F bond, a C—H bond, or a carbon-carbon bond. The peak derived from the oil-repellent agent may be a peak derived from a structural unit present not in the fluorine resin but in the oil-repellent agent, namely, a bond included in the structural unit present only in the oil-repellent agent.

Although the peak derived from the oil-repellent agent is not limited in particular, it may be a peak derived from at least one functional group selected from the group consisting of a hydroxy group, a carboxy group, an aldehyde group, a carbonyl group, an ester group, and an ether group. The functional group may be a functional group containing a heteroatom, especially an oxygen atom. The peak derived from the oil-repellent agent may be the largest peak among the peaks derived from bonds other than the C—F bond, the C—H bond, and the carbon-carbon bond.

The peak derived from the oil-repellent agent may be a peak derived from a carboxy group and/or an ether group. An example of the peak derived from the carboxy group is a peak present near 1700 cm⁻¹ to 1740 cm⁻¹, or more broadly around 1670 cm⁻¹ to 1770 cm⁻¹, and derived from the stretching vibration of the C═O bond in the carboxy group. The peak derived from the ether group is a peak present near 980 cm⁻¹ to 990 cm⁻¹, or more broadly around 950 cm⁻¹ to 1100 cm⁻¹, and derived from the stretching vibration of the C—O bond in the ether group (C—O—C).

In the present embodiment, the peak present near a predetermined wavenumber (for instance, 1740 cm⁻¹, 983 cm⁻¹, and 1150 cm⁻¹) is not only the peak having its peak top in the wavenumbers, but also a peak having its middle in the wavenumbers. The absorbance of a peak is determined according to the height of the peak top, even if the peak top deviates from the predetermined wavenumber.

The absorbance ratio R_{f} of the principal surface 11 and the absorbance ratio R_{b} of the principal surface 12 may both be positive values (R_{f}>0 and R_{b}>0). R_{b}>0 indicates that the oil-repellent agent is present also on the principal surface 12 of the porous fluorine resin membrane 1. The absorbance ratio R_{f} may be larger than the absorbance ratio R_{b} (R_{f}>R_{b}), or conversely, the absorbance ratio R_{b} may be larger than the absorbance ratio R_{f} (R_{f}<R_{b}). In a case of applying an oil-repellent agent from only the one principal surface, an excess amount of oil-repellent agent is supplied to obtain sufficient oil repellency, according to a conventional method. For this reason, even in a case of applying the oil-repellent agent only from the principal surface 11, the absorbance ratios for both principal surfaces 11 and 12 are substantially the same, similarly to a case where a membrane is soaked in an oil-repellent agent to supply the oil-repellent agent from both principal surfaces. More specifically, when the slight difference is taken into account, due to the excess oil-repellent agent reaching the principal surface 12, the R_{b} tends to be slightly larger than the R_{f} even though they are essentially the same. In the present embodiment, the absorbance ratio of the principal surface to which the oil-repellent agent is applied is higher than that of the principal surface to which no oil-repellent agent is applied, for instance, in a case of applying the oil-repellent agent only from the principal surface 11, R_{f}>R_{b} may hold true.

A study of the present inventor has revealed that an oversupply of the oil-repellent agent the oil-repellent agent may slightly increase the oil repellency but can significantly decline air permeability.

Though there is no particular limitation for the oil repellency of the principal surfaces 11 and 12, the principal surface 11 may have oil repellency that does not allow permeation of n-alkane having 15 carbon atoms, i.e., n-pentadecane. In the present embodiment, R_{f}>R_{b} holds true, and the one principal surface 11 may have oil repellency that does not allow permeation of n-alkane having 15 carbon atoms, in other words, n-pentadecane. The one principal surface 11 may have oil repellency that does not permeate n-alkane having 14, 13, 12, 10, 9, and even 8 carbon atoms. Here, n-alkanes having a relatively large numbers of carbon atoms do not permeate into the principal surface in which n-alkanes having a relatively small numbers of carbon atoms do not permeate. For instance, an oil-repellent surface that does not permeate n-alkanes having 8 carbon atoms, that is, n-octane, does not permeate n-alkanes having 9 to 15 carbon atoms.

In the present embodiment, the maximum pore diameter of the porous fluorine resin membrane and the Gurley air permeability of the porous fluorine resin membrane can satisfy at least one of the following a) to c).
a) A maximum pore diameter is 75 nm or less, a Gurley air permeability is 160 seconds/100 mL or less.
b) A maximum pore diameter is 150 nm or less, a Gurley air permeability is 80 seconds/100 mL or less.
c) A maximum pore diameter is 900 nm or less, a Gurley air permeability is 12 seconds/100 mL or less.

In a), the maximum pore diameter may be 70 nm or less, or even may be 65 nm or less. In a), the Gurley air permeability may be 150 seconds/100 mL or less, or even 10 may be 140 seconds/100 mL or less. In b), the maximum pore diameter may be 140 nm or less, or even may be 130 nm or less. In b), the Gurley air permeability may be 70 seconds/100 mL or less, or even may be 60 seconds/100 mL or less. In c), the maximum pore diameter may be 800 nm or less, or even may be 750 nm or less. In c), the Gurley air permeability may be 10 seconds/100 mL or less.

In the present embodiment, the Gurley air permeability of the porous fluorine resin membrane may be 90 seconds/100 mL or less, may be 80 seconds/100 mL or less, or may be 60 seconds/100 mL or less, in some cases, may be 20 seconds/100 mL or less. Though there is no particular limitation, the Gurley air permeability may be 1 seconds/100 mL or more.

In the present embodiment, the rate of difference between the absorbance ratio of the principal surface 11 and the absorbance ratio of the principal surface 12 calculated by Formula (2) below may be 4% or more.

$$100 \times ( {R}_{f} - {R}_{b} ) / {R}_{f} \qquad Formula ( 2 )$$

The absorbance ratio R_{f} of the principal surface 11 may be not particularly limited, but for instance, it may be 0.005 or more, and even may be 0.007 or more. The upper limit for the R_{f} may be, for instance, 0.050 (R_{f}≤0.050), or may be 0.040 (R_{f}≤0.040).

The upper limit of the rate of difference between the absorbance ratio of the principal surface 11 and the absorbance ratio of the principal surface 12 is 99% for instance. The upper limit of the rate of difference between the absorbance ratio of the principal surface 11 and the absorbance ratio of the principal surface 12 may be 95%.

The absorbance ratio at a depth of 40 to 60% of the porous fluorine resin membrane 1 in the thickness direction of the porous fluorine resin membrane 1 from the principal surface 11 is defined as Rₘ. In this case, the absorbance ratio Rₘ may be 0.0025 or more (Rₘ≥0.0025). By applying the oil-repellent treatment not only to the principal surface 11 but also to the vicinity of the center of the membrane, oil repellency can be stably exhibited. The absorbance ratio Rₘ may be 0.005 or more (Rₘ≥0.005).

The upper limit of the absorbance ratio Rₘ is, for instance, 0.030 (Rₘ≤0.030). The upper limit of the absorbance ratio Rₘ may be 0.025 (Rₘ≤0.025).

The R_{b} may be 0.001 or more (R_{b}≥0.001). A thickness of a part of the porous fluorine resin membrane 1 in which the oil-repellent agent has permeated is defined as the oil repellent layer. At this time, the oil-repellent layer may have a thickness equivalent to the thickness of the porous fluorine resin membrane 1 so that the absorbance ratio R_{f} and the absorbance ratio R_{b} are not substantially the same. The oil-repellent layer may have a thickness equivalent to the thickness of the porous fluorine resin membrane 1 so that the rate of difference in the absorbance ratios calculated by Formula (2) is 4% or more.

The R_{f}, the Rₘ and the R_{b} may satisfy R_{f}>Rₘ>R_{b}. The Rₘ and the R_{b} may satisfy Rₘ>1.1 R_{b}. When observing the cross section in the thickness direction of the porous fluorine resin membrane 1 as shown in FIG. 2, the oil-repellent agent may be distributed in a gradation pattern in which the amount of the oil-repellent agent gradually decreases from the principal surface 11 toward the principal surface 12.

As long as the absorbance ratio R_{f} of the principal surface 11 and the absorbance ratio R_{b} of the principal surface 12 are not substantially the same, the state of distribution of the oil-repellent agent in the porous fluorine resin membrane 1 is not limited to the example shown in FIG. 2. For instance, when observing the cross section in the thickness direction of the porous fluorine resin membrane 1, the oil-repellent agent may be distributed so that the amount of the oil-repellent agent decreases from the principal surface 11 toward the center, and the amount of the oil-repellent agent slightly increases from the center toward the principal surface 12.

The porous fluorine resin membrane 1 is a membrane formed by stretching, typically by biaxially stretching, a fluorine resin membrane to make it porous. The porous fluorine resin membrane 1 may have countless pores formed during stretching, more specifically, pores as voids between countless fluorine resin fibrils formed during the stretching.

The porous fluorine resin membrane 1 may be a single-layer membrane. The porous fluorine resin membrane 1 may be a layered film formed of a plurality of layers.

Examples of fluorine resin to be included in the porous fluorine resin membrane 1 include polytetrafluoroethylene (PTFE), polychlorotrifluoroethylene, a tetrafluoroethylene-hexafluoropropylene copolymer, and a tetrafluoroethylene-ethylene copolymer.

The fluorine resin may be PTFE. That is, the porous fluorine resin membrane 1 may be a porous PTFE membrane. Since the porous PTFE membrane has excellent water resistance and dustproof properties, in a case of application to the air-permeable filter 10, the membrane exhibits an excellent function of preventing foreign matters such as water and dust from entering the housing from the outside. The housing is, for instance, a housing of an electronic device such as a smart watch or a mobile phone.

The oil-repellent agent may include a fluorine-containing polymer.

The fluorine-containing polymer may include a carboxy group. The fluorine-containing polymer may include a polymer including as a monomer a compound represented by CH₂═CR¹COOR². Here, the R¹ is either a hydrogen atom or a methyl group. The R² is a hydrocarbon group in which at least one hydrogen atom is substituted by a fluorine atom. The R² may be an alkyl group in which at least one hydrogen atom is substituted by a fluorine atom. The numbers of carbon atoms of the R² may be 1 to 20, or even may be 3 to 18.

The R² may be a linear fluorine-containing hydrocarbon group. The linear fluorine-containing hydrocarbon group may be represented by (i) —R³C₅F₁₀CH₂C₄F₉, or (ii) —R⁴C₆F₁₃. Here, the R³ and the R⁴ are each independently an alkylene group or a phenylene group having 1 to 12, preferably 1 to 10 carbon atoms. The linear fluorine-containing hydrocarbon group represented by (i) or (ii) above becomes a linear fluoroalkyl group when the R³ or the R⁴ is an alkylene group. The above-described expression “linear” is employed to clarify that the carbon skeleton of the fluorine-containing hydrocarbon group does not have two or more branched ends, but inclusion of a phenylene group as the R³ or the R⁴ is not excluded.

The linear perfluoroalkyl group (hereinafter referred to as a Rf group and described as Rf in the formula) is a functional group that exhibits low surface free energy and imparts high oil repellency to the coated surface. In particular, an Rf group having 8 or more carbon atoms (CₙF₂ₙ: n is an integer of 8 or more) is known to exhibit excellent oil repellency due to its high crystallinity. However, oil-repellent treatment using an oil-repellent agent including an R_{f} group having 8 or more carbon atoms may significantly decline the air permeability of the porous fluorine resin membrane 1. A fluorine-containing polymer may not necessarily include an R_{f} group having 8 or more carbon atoms. An oil-repellent agent having the aforementioned (i) or (ii) as the linear fluorine-containing hydrocarbon group is capable of imparting oil repellency sufficient for practical use without considerable decline in the air permeability even when the oil-repellent agent coats the surface of the porous fluorine resin membrane 1.

As indicated by the chemical formula above, the linear fluorine-containing hydrocarbon group-containing monomer may have a methacrylate structure or an acrylate structure in its main chain.

The above-described compound may be represented by Chemical Formula (a) below.

CH₂=C(CH₃)COOCH₂CH₂C₅F₁₀CH₂C₄F₉ (a)

The above-described compound may be represented by Chemical Formula (b) below.

CH₂=CHCOOCH₂CH₂C₆F₁₃ (b)

As the oil-repellent agent, an oil-repellent agent including a copolymer that includes a linear fluorine-containing hydrocarbon group-containing monomer and a crosslinkable monomer may be used.

The crosslinkable monomer includes at least one selected from the group consisting of an alkoxy group-containing monomer, a hydroxy group-containing monomer and a carboxy group-containing monomer. The crosslinkable monomer may have a methacrylate structure or an acrylate structure in its main chain. As the alkoxy group-containing monomer, for instance, 3-methacryloxypropyltriethoxysilane can be used. As the hydroxy group-containing monomer, for instance, 2-hydrooxyethyl methacrylate can be used. As the carboxy group-containing monomer, for instance, 2-carboxyethyl methacrylate can be used. The crosslinkable monomer preferably has a copolymerization ratio of 0.1 to 40 mol %, particularly 1 to 10 mol %, in order to prevent or reduce melting of the oil-repellent agent at high temperatures and to ensure that the imparting of oil repellency is not hindered. Among them, an alkoxy group-containing monomer and a carboxy group-containing monomer are preferred due to the high crosslinking reactivity, and an alkoxy group-containing monomer is particularly preferred.

The oil-repellent agent may be a polyether-based oil-repellent agent. The fluorine-containing polymer included in the oil-repellent agent may include perfluoropolyether. The perfluoropolyether includes an ether group, more specifically a unit structure represented by —(Rf—O)—.

The perfluoropolyether is a perfluorinated polyether, which is mainly formed of carbon, fluorine, and oxygen. The perfluoropolyether has a variety of structures. The perfluoropolyether may further include a perfluorinated side chain.

As the perfluoropolyether, commercially-available perfluoropolyether, for instance KRYTOX (registered trademark), FOMBLIN (registered trademark), HOSTINERT and DEMNUM (registered trademark) can be used.

The perfluoropolyether may have a repeating unit as shown by Chemical Formula (c) below.

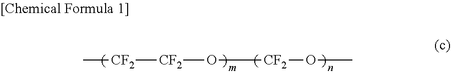

In Chemical Formula (c), the ratio of m:n, expressed as m/n, is 2/3, for instance.

The perfluoropolyether may have a repeating unit as shown by Chemical Formula (d) below.

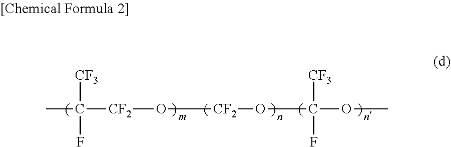

In Chemical Formula (d), the ratio of m:n:n′, expressed as m/n/n′, is 40/1/1, for instance.

The perfluoropolyether may have a repeating unit as shown by Chemical Formula (e) below.

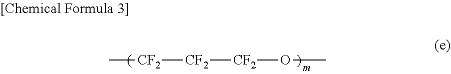

The perfluoropolyether may have a repeating unit as shown by Chemical Formula (f) below.

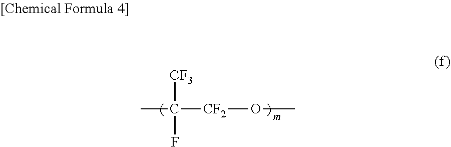

In Chemical Formulae (e) and (f), m is an integer of 1 or more.

An acrylate-based oil-repellent agent having perfluoropolyether in its side chain may be represented by Chemical Formula (g) below.

CH₂=CH₂COOCH₂CH₂NHCOCFCF₃—(OCF₂CF(CF₃))ₙ—OCF₂CF₂CF₃ (g)

A methacrylate-based oil-repellent agent having perfluoropolyether in its side chain may be represented by Chemical Formula (h) below.

CH₂=CH(CH₃)COOCH₂CH₂NHCOCFCF₃—(OCF₂CF(CF₃))ₙ—OCF₂CF₂CF₃ (h)

In Chemical Formulae (g) and (h), n is an integer of 1 or more.

As the oil-repellent agent, an oil-repellent agent including a copolymer that includes a linear fluorine-containing hydrocarbon group-containing monomer and a crosslinkable monomer may be used.

The oil-repellent agent is not limited to the aforementioned examples. The oil-repellent agent may include a functional group other than a carboxy group and an ether group. The oil-repellent agent may include at least one functional group selected from the group consisting of a hydroxy group, an aldehyde group, a carbonyl group, and an ester group.

For the porous fluorine resin membrane 1, the water entry pressure on the principal surface 11 relative to an aqueous solution of isopropanol (hereinafter referred to as IPA) with a concentration of 30% by weight may be 180 kPa or more. The water entry pressure relative to the IPA aqueous solution may be 200 kPa or more. In this specification, in accordance with common usage, the liquid entry pressure measured using an aqueous solution instead of water is also referred to as “water entry pressure”.

The upper limit of water entry pressure for the IPA aqueous solution is 400 kPa for instance. The upper limit of water entry pressure for the above IPA aqueous solution may be 350 kPa.

For the porous fluorine resin membrane 1, the water entry pressure on the principal surface 11 relative to the IPA aqueous solution with a concentration of 30% by weight can be measured using a measurement jig and according to Method B of water resistance test (high water pressure method) specified in JIS L1092:2009, as specified below.

An example of the measurement jig is a stainless-steel disc having a diameter of 47 mm and having a through hole (with a circular cross section) with a diameter of 1.0 mm at the center thereof. The disc has a thickness sufficient to prevent the disc from deforming due to the water pressure applied upon measurement of the water entry pressure. Measurement of water entry pressure using the measurement jig can be performed as follows.

A porous fluorine resin membrane 1 to be evaluated is fixed to one surface of the measurement jig so as to cover the opening of the through hole of the measurement jig. The fixation is performed such that the IPA aqueous solution does not leak from the fixed portion of the membrane during measurement of water entry pressure. For fixing the porous fluorine resin membrane 1, a double-faced adhesive tape having a water port punched in a center portion thereof with a shape that matches the shape of the opening can be used. The double-faced adhesive tape can be disposed between the measurement jig and the porous fluorine resin membrane 1 such that the circumference of the water port and the circumference of the opening coincide with each other. Next, the measurement jig having the porous fluorine resin membrane 1 fixed thereto is set on a testing apparatus such that the surface opposite to the surface on which the porous fluorine resin membrane 1 is fixed is a water pressure application surface to which water pressure is applied during measurement, and a water entry pressure is measured according to Method B of water resistance test in JIS L1092: 2009. The water entry pressure is measured based on the water pressure when the IPA aqueous solution comes out from one spot on the surface of the porous fluorine resin membrane 1. The measured water entry pressure can be regarded as the water entry pressure on the principal surface 11 of the porous fluorine resin membrane 1 relative to the IPA aqueous solution with a concentration of 30% by weight. As the testing apparatus, an apparatus that has the same configuration as the water resistance testing apparatus exemplified in JIS L1092: 2009 and that has a test piece attachment structure capable of setting the measurement jig can be used.

The average thickness of the porous fluorine resin membrane 1 varies depending on the application, but may be 100 μm or less, may be 75 μm or less, may be 50 μm or less, or even may be 25 μm or less. The lower limit of the average thickness of porous fluorine resin membrane 1 is, for instance, 3 μm or more.

The Gurley air permeability was measured in accordance with Method B of air permeability measurement (Gurley method) specified in JIS L1096:2010.

Even if the size of the porous fluorine resin membrane 1 is smaller than the size of the test piece in the Gurley method (approximately 50 mm×50 mm), use of the measurement jig allows evaluation of the Gurley air permeability. An example of the measurement jig is a disc made of polycarbonate and provided with a through hole (having a circular cross section with a diameter of 1.0 mm) at the center thereof and having a thickness of 2 mm and a diameter of 47 mm. Measurement of water entry pressure using the measurement jig can be performed as follows.

The porous fluorine resin membrane 1 to be evaluated is fixed to one surface of the measurement jig so as to cover the opening of the through hole of the measurement jig. The fixation is performed such that, during measurement of a Gurley air permeability, air passes through only the opening and an effective test portion (portion overlapping the opening when viewed in a direction perpendicular to a principal surface 11 and the principal surface 12 of the fixed porous fluorine resin membrane 1) of the porous fluorine resin membrane 1 to be evaluated, and the fixed portion of the porous fluorine resin membrane 1 does not hinder passage of air through the effective test portion of the porous fluorine resin membrane 1. For fixing the porous fluorine resin membrane 1, a double-sided adhesive tape having a ventilation port punched in a center portion thereof with a shape that matches the shape of the opening can be used. The double-sided adhesive tape can be placed between the measurement jig and the porous fluorine resin membrane 1 such that the circumference of the ventilation port and the circumference of the opening match each other. Next, the measurement jig having the porous fluorine resin membrane 1 fixed thereto is set on a Gurley air permeability testing machine such that the surface on which the porous fluorine resin membrane 1 is fixed is at the downstream side of airflow during measurement, and a time t1 taken for 100 mL of air to pass through the porous fluorine resin membrane 1 is measured. Next, the measured time t1 is converted into a value t per effective test area of 642 [mm²] specified in Method B of air permeability measurement (Gurley method) in JIS L1096: 2010, by the equation t={(t1)×(area of effective test portion of porous fluorine resin membrane 1 [mm²])/642 [mm²]}, and the obtained conversion value t can be regarded as the Gurley air permeability of the porous fluorine resin membrane 1. In a case where the above disc is used as the measurement jig, the area of the effective test portion of the porous fluorine resin membrane 1 is the area of the cross section of the through hole. It has been confirmed that the Gurley air permeability measured without using the measurement jig for the porous fluorine resin membrane 1 satisfying the test piece size and the Gurley air permeability measured using the measurement jig after fragmenting the porous fluorine resin membrane 1 coincide well with each other, that is, the use of the measurement jig does not substantially affect the measured values of the Gurley air permeability.

The porosity of porous fluorine resin membrane 1 is 25% or more, for instance.

The porosity of the porous fluorine resin membrane 1 may be 63% or more. The porosity can be calculated by substituting a mass, a thickness, an area (area of principal surface), and a true density of the membrane into Formula (3) below. For instance, in a case where the porous fluorine resin membrane 1 is a porous PTFE membrane, a true density of the PTFE is 2.18 g/cm³.

$$Porosity ( \% ) = \{ 1 - ( mass [ g ] / ( thickness [ cm ] \times area [ {cm}^{2} ] \times true density [ g / {cm}^{3} ] ) ) \} \times 100 \qquad Formula ( 3 )$$

The upper limit of porosity for porous fluorine resin membrane 1 is 95%, for instance. The upper limit of the porosity may be 90%.

The principal surface 11 of the porous fluorine resin membrane 1 may be colored. For instance, in a case where the porous fluorine resin membrane 1 is a porous PTFE membrane, the porous PTFE membrane is usually white in color and accordingly noticeable when disposed over an opening. Noticeable gas-permeable membranes can easily impair the design of electronic devices, and also stimulate the curiosity of users and accordingly are susceptible to damages by puncturing with a writing instrument or the like. Coloring the principal surface 11 can prevent or reduce the problems.

The principal surface 11 may be colored black or gray. The porous fluorine resin membrane 1 colored black or gray will not be noticeable if the membrane is disposed so that the principal surface 11 having a relatively low lightness L* is visible from the outside. Lightness L* means the lightness L* of the CIE1976 (L*, a*, b*) color space specified in JIS Z8781-4:2013.

Although the colorant may be a dye or a pigment, the colorant is preferably a dye from the viewpoint of preventing detachment from the porous PTFE membrane 1. Detachment from the porous fluorine resin membrane 1 might cause discoloration of the porous fluorine resin membrane 1, or might cause damage to electrical circuits or electronic components located near the porous fluorine resin membrane 1 in a case where the colorant is electroconductive. Furthermore, when the colorant is a dye or an insulating pigment, an insulating porous fluorine resin membrane 1 can be obtained based on high insulating properties derived from the fluorine resin. The insulating properties are expressed by a surface resistivity of, for instance, 1×10¹⁴Ω/□ or more on at least one of the principal surfaces 11 and 12. The surface resistivity may be 1×10¹⁵Ω/□ or more, 1×10¹⁶Ω/□ or more, or even 1×10¹⁷Ω/□ or more.

Examples of the dye include an azo dye and an oil-soluble dye, and examples of the pigment include carbon black and metal oxide, though the dye and the pigment are not limited to these examples.

The maximum pore diameter of the porous fluorine resin membrane 1 is 1000 nm or less, for instance. The maximum pore diameter of the porous fluorine resin membrane 1 may be 500 nm or less. A porous fluorine resin membrane 1 with a small maximum pore diameter is advantageous in achieving high water entry pressure.

The maximum pore diameter r of the porous fluorine resin membrane 1 can be calculated using Formula (4) below, which indicates the limit water entry pressure h due to water.

$$\begin{matrix}[ Equation 1 ] & \\ h = \frac{2 T}{Sg} \cdot cos θ \frac{1}{r} & Formula ( 4 )\end{matrix}$$

In Formula (4), T indicates the surface tension (dyne/cm) of water. S indicates the density of water (g/cm³). g indicates the gravitational acceleration (cm/sec²). θ indicates the water contact angle with respect to the porous fluorine resin membrane 1. The threshold water entry pressure value h due to water can be measured in accordance with Method B of water resistance test (high water pressure method) specified in JIS L1092:2009 mentioned above. This measurement jig has a through hole with a diameter of 1.0 mm at the center thereof.

The maximum pore diameter of the porous fluorine resin membrane 1 may be 300 nm or less. The lower limit of the maximum pore diameter of the porous fluorine resin membrane 1 is, for instance, 50 nm. In order to obtain a porous fluorine resin membrane 1 having a maximum pore diameter of not more than a predetermined value, a membrane with a maximum pore diameter of not more than the value can be selected as the original porous fluorine resin membrane before being subjected to an oil-repellent treatment.

The shape of the air-permeable filter 10 is, for instance, a polygon including a square and a rectangle, a circle, an ellipse, an indeterminate form, and a strip when viewed from the direction perpendicular to the principal surface 11 and the principal surface 12, though the shape of the air-permeable filter 10 is not limited to the above-described examples.

The air-permeable filter 10 shown in FIG. 1 is formed of the porous fluorine resin membrane 1.

### [Method for Manufacturing Air-Permeable Filter]

A method for manufacturing an air-permeable filter 10 is explained below. The air-permeable filter 10 can be manufactured, for instance, by the method described below.

First, an original porous fluorine resin membrane is prepared. The original porous PTFE membrane can be formed by a known method. For instance, in a case where the porous fluorine resin membrane 1 is a porous PTFE membrane, the membrane can be formed as follows: a kneaded product of a PTFE fine powder and a molding aid is formed into a sheet by extrusion molding and rolling; the molding aid is removed from the sheet to obtain a sheet molded body; and then furthermore the sheet molded body is stretched. Note that the properties of the porous PTFE membrane can be adjusted by the rolling conditions and the stretching conditions.

Next, an oil-repellent agent is applied to one principal surface of the original porous fluorine resin membrane (application step). In the application step, it may be preferable to apply the oil-repellent agent to the one principal surface so that the wet thickness is not more than twice the thickness of the original porous fluorine resin membrane.

A preferred method for applying the oil-repellent agent allows the oil-repellent agent to be applied at a relatively high concentration to the one principal surface of the original porous fluorine resin membrane. The relatively high concentration mentioned above indicates that the concentration of the oil-repellent agent in the treatment liquid as a mixture of the oil-repellent agent and a solvent is 0.8 to 10.0% by weight. The concentration of the oil-repellent agent may be 1.0 to 7.5% by weight.

Examples of methods that can apply an oil-repellent agent at a relatively high concentration include slot-die coating, gravure coating, spin coating, and bar coating. The slot-die coating and the gravure coating are preferred in particular because these methods allow easy control of the wet thickness of the oil-repellent agent and impart favorable handleability. The dip coating (impregnation) is a method for applying an oil-repellent agent to both principal surfaces of the original porous fluorine resin membrane. In the dip coating, the oil-repellent agent permeates almost uniformly throughout the original porous fluorine resin membrane, and thus, it is difficult to distribute the oil-repellent agent so as to impart a difference between the absorbance ratio R_{f} of the one principal surface 11 and the absorbance ratio R_{b} of the other principal surface 12 in the air-permeable filter 10.

In the slot-die coating, the wet thickness (flow rate/line speed) of the oil-repellent agent is determined by specifying the discharge amount (flow rate) and the line speed of the oil-repellent agent per unit application width. In the slot-die coating, the wet thickness of the oil-repellent agent is 5 to 100 μm, for instance. The lower limit of the oil-repellent agent wet thickness may be 10 μm. The upper limit of the wet thickness of the oil-repellent agent may be 80 μm, or may be 70 μm.

In the gravure coating, the wet thickness of the oil-repellent agent is determined by specifying the gravure roll speed. In the gravure coating, the wet thickness of the oil-repellent agent is 5 to 100 μm, for instance. The lower limit of the wet thickness of the oil-repellent agent may be 10 μm. The upper limit of the wet thickness of the oil-repellent agent may be 80 μm, or may be 70 μm.

According to the manufacturing method, the oil-repellent agent applied to the one principal surface in the coating step permeates into the interior of the original porous fluorine resin membrane, but permeation of the oil-repellent agent into the entire original porous fluorine resin membrane may be prevented or reduced. Therefore, it is possible to distribute the oil-repellent agent so as to impart a difference between the absorbance ratio R_{f} of the principal surface 11 and the absorbance ratio R_{b} of the principal surface 12 in the air-permeable filter 10.

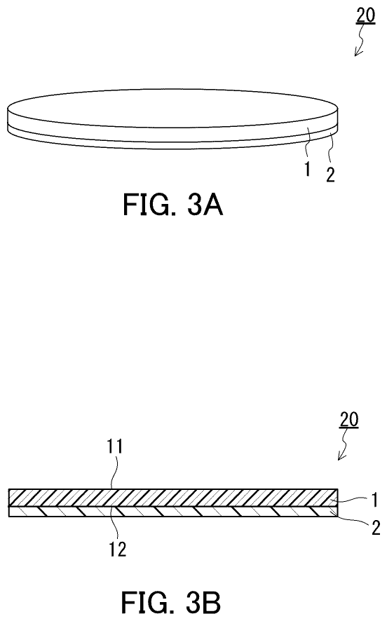

Another example of air-permeable filter of the present invention is shown in FIG. 3A and FIG. 3B. FIG. 3B shows a cross section of an air-permeable filter 20 shown in FIG. 3A. The air-permeable filter 20 in FIG. 3A and FIG. 3B further includes a support layer 2 that supports the porous fluorine resin membrane 1.

In the example shown in FIG. 3A and FIG. 3B, the support layer 2 is disposed on the principal surface 12 of the porous fluorine resin membrane 1. Alternatively, the support layer 2 may be disposed on the principal surface 11 of the porous fluorine resin membrane 1. Support layers 2 may be disposed on both the principal surface 11 and the principal surface 12 of the porous fluorine resin membrane 1.

In the example of FIG. 3A and FIG. 3B, the support layer 2 has a shape to correspond to the shape of the porous fluorine resin membrane 1 when viewed from the direction perpendicular to the principal surface 11 and the principal surface 12, and more specifically, it is shaped circular, though the shapes of the porous fluorine resin membrane 1 and the support layer 2 are not limited to the example. The air-permeable filter 20 with the support layer 2 is capable of reinforcing the porous fluorine resin membrane 1 and improving the handleability.

The support layer 2 is shaped like a net or a mesh and it has air permeability in the thickness direction. The support layer 2 has air permeability that is usually higher than the air permeability of the porous fluorine resin membrane 1. The support layer 2 has a function of ensuring the strength and rigidity of the air-permeable filter 20, improving its handleability, and preventing or reducing damage in attachment to a housing of an electronic device or the like and in a use thereof.

Materials for configuring the support layer 2 may not be limited particularly, and the examples include metals such as aluminum and stainless steel, resins such as polyolefin (e.g., polyethylene, or polypropylene), polyester (e.g., polyethylene terephthalate), polyamide (e.g., aliphatic polyamide or aromatic polyamide), and composite materials thereof.

The material that constitutes the support layer 2 is typically a polyolefin-based non-woven fabric.

### [Method for Manufacturing Air-Permeable Filter]

The air-permeable filter 20 can be manufactured, for instance, by layering the support layer 2 on the principal surface 12 of the porous fluorine resin membrane 1 for the air-permeable filter 10 manufactured by the above-described method for manufacturing the air-permeable filter 10. For layering the air-permeable filter 10 and the support layer 2, various bonding methods can be used, and the examples include, thermal lamination, heat welding, ultrasonic welding, or bonding with an adhesive agent or a pressure-sensitive adhesive agent.

### [Air-Permeable Member]

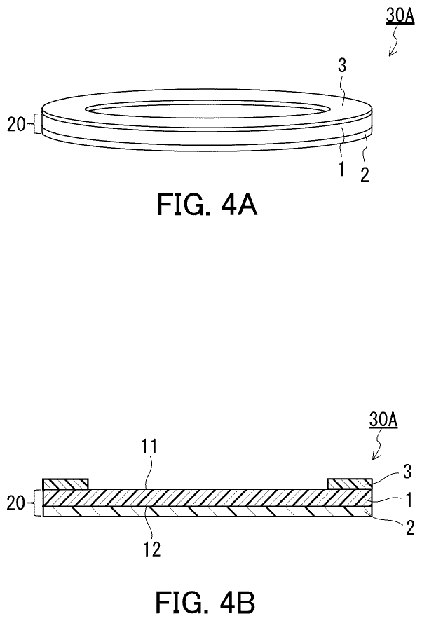

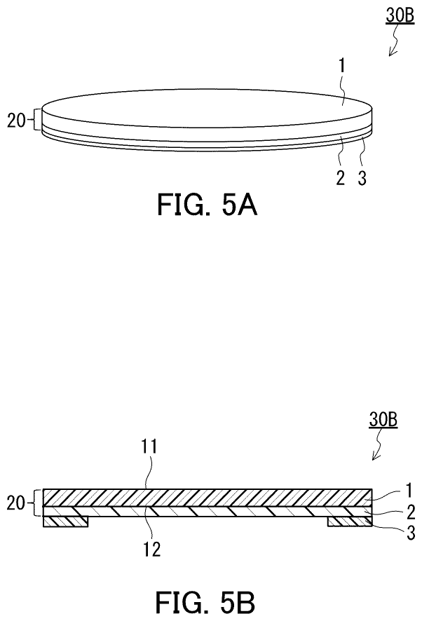

An example of air-permeable member of the present invention is shown in FIG. 4A and FIG. 4B. FIG. 4B shows a cross section of an air-permeable member 30A shown in FIG. 4A. The air-permeable member 30A includes an air-permeable filter 10 or 20, and a pressure-sensitive adhesive layer 3 bonded to the air-permeable filter 10 or 20. That is, FIG. 4A and FIG. 4B show an example provided with the air-permeable filter 20. In the air-permeable member 30A, the pressure-sensitive adhesive layer 3 is disposed on the principal surface 11 of the porous fluorine resin membrane 1. Alternatively, the pressure-sensitive adhesive layer 3 may be disposed on the principal surface 12 of the porous fluorine resin membrane 1. FIG. 5A and FIG. 5B show another example of air-permeable member of the present invention. FIG. 5B shows a cross section of an air-permeable member 30B shown in FIG. 5A. In the air-permeable member 30B, a pressure-sensitive adhesive layer 3 is disposed on the support layer 2 on the principal surface 12 of the porous fluorine resin membrane 1. The pressure-sensitive adhesive layer 3 may be disposed on both the principal surface 11 and the principal surface 12.

In the examples shown in FIG. 4A to FIG. 5B, the shape of the pressure-sensitive adhesive layer 3 corresponds to the shape of the peripheral portion of the air-permeable filter 20 when viewed from a direction perpendicular to the principal surface 11 and the principal surface 12, more specifically, it is shaped like a ring. In this case, the pressure-sensitive adhesive layer 3 can be used as an attachment part for the air-permeable filter 20, though the shapes of the air-permeable filter 20 and the pressure-sensitive adhesive layer 3 are not limited to the above examples as long as they can be attached to an opening of a housing of an electronic device or the like or an opening of an electronic component.

The air-permeable members 30 (30A, 30B) may be attached to an opening of a housing of an electronic device or the like or an opening of an electronic component, using a pressure-sensitive adhesive layer 3 so that the principal surface 11 of the porous fluorine resin membrane 1 faces outside. Alternatively, the air-permeable member 30 may be attached to an opening of a housing of an electronic device or the like or an opening of an electronic component so that the principal surface 11 of the porous fluorine resin membrane 1 faces inside.

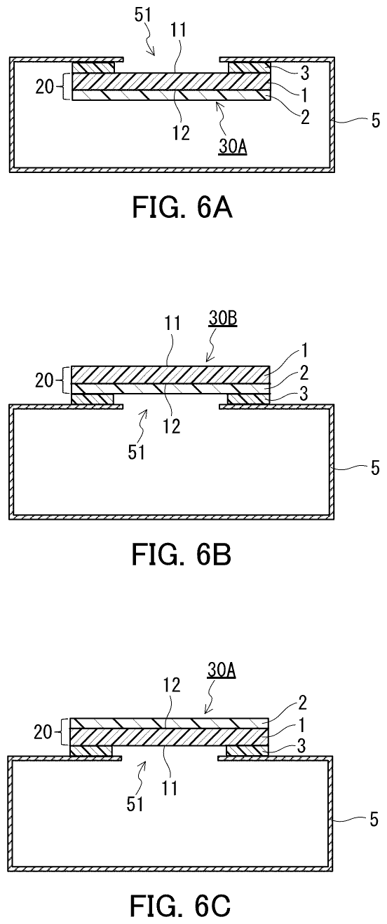

FIG. 6A and FIG. 6B are cross-sectional views schematically showing an example of attaching the air-permeable member 30 to an opening in a housing of an electronic device or the like or an opening of an electronic component so that the principal surface 11 of the porous fluorine resin membrane 1 faces outside. In FIG. 6A, the air-permeable member 30A is attached to an opening 51 in a housing or an electronic component 5 by a pressure-sensitive adhesive layer 3 so that the principal surface 11 of the porous fluorine resin membrane 1 is disposed outside. In FIG. 6B, the air-permeable member 30B is attached to an opening 51 in a housing or an electronic component 5 by a pressure-sensitive adhesive layer 3 so that the principal surface 11 of the porous fluorine resin membrane 1 faces outside.

FIG. 6C is a cross-sectional view schematically showing an example in which the air-permeable member 30 is attached to an opening in a housing of an electronic device or the like or an opening of an electronic component so that the principal surface 11 of the porous fluorine resin membrane 1 is disposed inside. In FIG. 6C, the air-permeable member 30A is attached to an opening 51 of a housing or an electronic component 5 by a pressure-sensitive adhesive layer 3 so that the principal surface 11 of the porous fluorine resin membrane 1 is disposed inside. Note that the embodiment shown in FIG. 6C refers to an application in which a liquid is held inside the housing 5 (for instance, an ink cartridge).

Embodiments for attaching the air-permeable member 30 to an opening in a housing of an electronic device or an opening in an electronic component are not limited to the above-described example, but various embodiments can be selected.

For instance, the pressure-sensitive adhesive layer 3 may be a double-sided adhesive tape.

### [Method for Manufacturing Air-Permeable Member]

The air-permeable member 30 can be manufactured by, for instance, bonding a pressure-sensitive adhesive layer 2 to the principal surface 11 of the porous fluorine resin membrane 1 of the air-permeable filter 10 or 20 manufactured by the aforementioned method for manufacturing the air-permeable filter 10 or 20.

### EXAMPLES

Hereinafter, the present invention will be described in more detail by way of Examples. The present invention is not limited to the following Examples.

First, a method of evaluating air-permeable filters manufactured in Examples will be described.

### [Measurement of Absorption Spectrum by FT-IR]

With an FT-IR spectrometer (4700 manufactured by Thermo Electron Corporation, and Quest manufactured by SPECAC Ltd.), the absorption spectrum was measured by a reflection method (ATR method) at a wavenumber of 650 cm⁻¹ to 4000 cm⁻¹, a resolution of 4.0 cm⁻¹, and 64 integrations. From the obtained absorption spectrum, the absorbance ratio R_{f} of the one principal surface and the absorbance ratio R_{b} of the other principal surface were calculated by Formula (1) below, using an absorbance Aₐ at a peak derived from the oil-repellent agent and an absorbance Aₘ at a peak derived from the C—F bond.

In a case where the peak derived from the oil-repellent agent was a peak derived from a carboxy group, the absorbance of the peak present near 1700 cm⁻¹ to 1740 cm⁻¹ was employed as the absorbance Aₐ. In a case where the peak derived from the oil-repellent agent was a peak derived from an ether group, the absorbance of the peak present near 980 cm⁻¹ to 990 cm⁻¹ was employed as the absorbance Aₐ. For an absorbance Aₘ, a peak absorbance present near 1150 cm⁻¹ was employed.

$${A}_{a} / {A}_{m} \qquad Formula ( 1 )$$

The rate of difference between the absorbance ratio of the one principal surface and the absorbance ratio of the other principal surface was calculated by Formula (2) below using the calculated absorbance ratios R_{f} and R_{b}.

$$100 \times ( {R}_{f} - {R}_{b} ) / {R}_{f} \qquad Formula ( 2 )$$

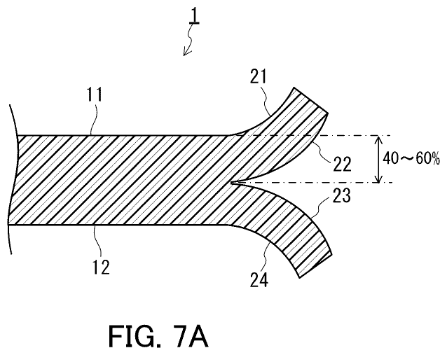

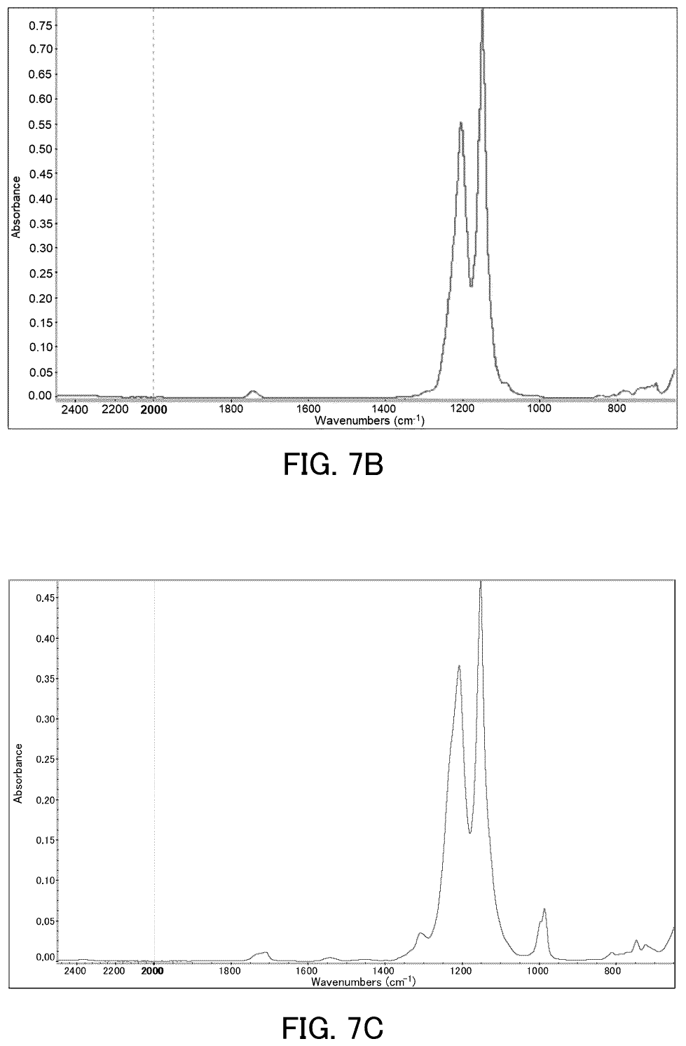

FIG. 7A is a schematic cross-sectional view to explain an absorption spectrum measurement by FT-IR. Specifically, the measurement was carried out for a porous fluorine resin membrane like the porous fluorine resin membrane 1 shown in FIG. 7A, which was in advance cut in a direction parallel to the principal surface 11 and the principal surface 12 at a depth of 40 to 60% of the porous fluorine resin membrane 1 from the principal surface 11 in the thickness direction of the porous fluorine resin membrane 1. The cutting was carried out by sandwiching each the one principal surface and the other principal surface of the porous fluorine resin membrane with double-sided tapes, and tearing the double-sided tapes apart from each other.

As shown in FIG. 7A, a measurement point 21 was set on the principal surface 11 of the porous fluorine resin membrane 1. A measurement point 22 was set on a surface, which was one of facing surfaces appeared by cutting the porous fluorine resin membrane 1 and which was closer to the principal surface 11. A measurement point 23 was set on a surface, which was one of the facing surfaces and closer to the principal surface 12. And a measurement point 24 was set on the principal surface 12 of the porous fluorine resin membrane 1. In other words, in the air-permeable filter of this Example, the absorbance ratio R_{f} of one principal surface of the porous fluorine resin membrane indicates an absorbance ratio at the measurement point 21 in FIG. 7A. The absorbance ratio Rₘ at a depth of 40 to 60% of the porous fluorine resin membrane in the thickness direction of the porous fluorine resin membrane from one principal surface indicates absorbance ratios at the measurement points 22 and 23 in FIG. 7A. In a case where the absorbance ratios at the measurement points 22 and 23 do not coincide with each other, the average value can be taken as the absorbance ratio at a depth of 40 to 60% of the membrane. The absorbance ratio R_{b} of the other principal surface of the porous fluorine resin membrane indicates the absorbance ratio at the measurement point 24 in FIG. 7A.

FIG. 7B shows an example of absorption spectrum by FT-IR. FIG. 7B refers to an example in which the oil-repellent agent includes a fluorine-containing polymer including a polymer whose monomer is a compound shown by Chemical Formula (a) below, and the porous fluorine resin membrane is a porous PTFE membrane. FIG. 7B corresponds to Example 7 described below.

CH₂=C(CH₃)COOCH₂CH₂C₅F₁₀CH₂C₄F₉ (a)

FIG. 7C shows another example of absorption spectrum by FT-IR. FIG. 7C refers to an example in which the oil-repellent agent includes a fluorine-containing polymer including a polymer whose monomer is a compound shown by Chemical Formula (g) below, and the porous fluorine resin membrane is a porous PTFE membrane. FIG. 7C corresponds to Example 20 described below.

CH₂=CH₂COWCOCH₂CH₂NHCOCFCF₃—(OCF₂CF(CF₃))ₙ—OCF₂CF₂CF₃ (g)

FIG. 7B and FIG. 7C show the absorbance at the measurement point 21 in FIG. 7A. It is possible to read the absorbance Aₐ of a peak (a peak present near 1700 cm⁻¹ to 1740 cm⁻¹) derived from a carboxy group and an absorbance Aₘ of a peak (a peak present near 1150 cm⁻¹) derived from a C—F bond, from the absorption spectrum of FIG. 7B. It is possible to read the absorbance Aₐ of a peak (a peak present near 980 cm⁻¹ to 990 cm⁻¹) derived from an ether group and an absorbance Aₘ of a peak (a peak present near 1150 cm⁻¹) derived from a C—F bond, from the absorption spectrum of FIG. 7C. From the respective absorbances Aₐ and Aₘ, the absorbance ratio R_{f} of the one principal surface and the absorbance ratio R_{b} of the other principal surface of the porous fluorine resin membrane in the air-permeable filter can be calculated by Formula (1) below. The rate of difference in the absorbance ratios in the porous fluorine resin membrane in the air-permeable filter can be calculated by Formula (2) below.

$${A}_{a} / {A}_{m} \qquad Formula ( 1 )$$

$$100 \times ( {R}_{f} - {R}_{b} ) / {R}_{f} \qquad Formula ( 2 )$$

### [Oil Repellency]

In accordance with an oil repellency test (AATCC 118), the oil repellency of the one principal surface of the porous fluorine resin membrane was tested by the following method. In the oil repellency test, a porous fluorine resin membrane was layered on paper, with the surface of the porous fluorine resin membrane to be tested facing up. A drop of linear alkane was applied thereon using a sipper, and after 30 seconds it was checked whether the membrane was wet or not. Oil repellency was then evaluated using the linear alkane with the smallest number of carbon atoms among the linear alkanes that did not wet the membrane. For instance, if it was hexane (C₆H₁₄), the oil repellency was expressed as C6. Table 1 below has indications of “C10Δ” and “C10×”. “C10Δ” indicates a case where C11 is definitely achievable, but it is not clear whether C10 is achievable or not. “C10×” indicates that C11 is definitely achievable, but C10 is almost impossible to achieve.

### [Gurley Air Permeability]

The Gurley air permeability was evaluated by the aforementioned method.

### [Air Permeability Decline Rate]

The air permeability decline rate was calculated as a decline rate of air permeability of the air-permeable filter relative to the air permeability of the original porous fluorine resin membrane before the oil-repellent treatment. The air permeability is proportional to the reciprocal of the Gurley air permeability. Therefore, when the Gurley air permeability of the original porous fluorine resin membrane is defined as B₁ and the Gurley air permeability of the air-permeable filter is defined as B₂, the air permeability decline rate of the air-permeable filter can be calculated using Formula (5) below.

$$100 \times \{ ( 1 / {B}_{1} ) - ( 1 / {B}_{2} ) \} / ( 1 / {B}_{1} ) \qquad Formula ( 5 )$$

### [Water Entry Pressure Relative to IPA Aqueous Solution]

The water entry pressure relative to the IPA aqueous solution was evaluated by the aforementioned method.

### [Porosity]

The porosity was evaluated by the aforementioned method.

### [Maximum Pore Diameter]

The maximum pore diameter of the original porous fluorine resin membrane before an oil-repellent treatment was calculated by the aforementioned method.

### [Manufacture of Original Porous Fluorine Resin Membrane]

### (Original Porous PTFE Membrane A)

An amount of 100 parts by mass of PTFE fine powder (F121 manufactured by DAIKIN INDUSTRIES, LTD.) and 20.5 parts by mass of isoparaffin hydrocarbon (Isopar M manufactured by Exxon Mobil Corporation) serving as a molding aid were uniformly mixed. The resulting mixture was compressed using a cylinder and then was molded to be sheet-like by ram extrusion. Next, the sheet-like mixture was rolled by passing between a pair of metal rolls to a thickness of 0.4 mm, and then heated to 150° C. to dry and remove the molding aid to form a sheet-formed body. Next, the sheet-formed body was stretched in the longitudinal direction (rolling direction) at a stretching temperature of 300° C. and a stretching ratio of 4 times, later in the width direction at a stretching temperature of 150° C. and a stretching ratio of 25 times, and then, the molded sheet was further fired at 400° C., whereby an original porous PTFE membrane A was obtained. The thus obtained original porous PTFE membrane A had an average thickness of 50 μm, a maximum pore diameter of 120 nm, and a porosity of 77.9%. The water entry pressure relative to the IPA aqueous solution was 106 kPa, and the Gurley air permeability B₁ was 30 seconds/100 mL.

### (Original Porous PTFE Membrane B)

An amount of 100 parts by mass of PTFE fine powder (F121 manufactured by DAIKIN INDUSTRIES, LTD.) and 20.5 parts by mass of isoparaffin hydrocarbon (Isopar M manufactured by Exxon Mobil Corporation) serving as a molding aid were uniformly mixed. The resulting mixture was compressed using a cylinder and then was molded to be sheet-like by ram extrusion. Next, the sheet-like mixture was rolled by passing between a pair of metal rolls to a thickness of 0.2 mm, and then heated to 150° C. to dry and remove the molding aid to form a sheet-formed body. Next, the sheet-formed body was stretched in the longitudinal direction (rolling direction) at a stretching temperature of 300° C. and a stretching ratio of 4 times, later in the width direction at a stretching temperature of 150° C. and a stretching ratio of 40 times, and then, the molded sheet was further fired at 400° C., whereby an original porous PTFE membrane B was obtained. The thickness of the thus obtained original porous PTFE membrane B was 5 μm, the maximum pore diameter was 150 nm, the porosity was 76%, the water entry pressure relative to an IPA aqueous solution was 100 kPa, and the Gurley air permeability B₁ was 1.4 seconds/100 mL.

### (Original Porous PTFE Membrane C)

An amount of 100 parts by mass of PTFE fine powder (CD123E manufactured by AGC Inc.) and 20.5 parts by mass of isoparaffin hydrocarbon (Isopar M manufactured by Exxon Mobil Corporation) serving as a molding aid were uniformly mixed. The resulting mixture was compressed using a cylinder and then was molded to be sheet-like by ram extrusion. Next, the sheet-like mixture was rolled by passing between a pair of metal rolls to a thickness of 0.2 mm, and then heated to 150° C. to dry and remove the molding aid to form a sheet-formed body. Next, the sheet-formed body was stretched in the longitudinal direction (rolling direction) at a stretching temperature of 150° C. and a stretching ratio of 4 times, later in the width direction at a stretching temperature of 150° C. and a stretching ratio of 20 times, and then, the molded sheet was further fired at 400° C., whereby an original porous PTFE membrane C was obtained. The thickness of the thus obtained original porous PTFE membrane C was 5 μm, the maximum pore diameter was 700 nm, the porosity was 89%, the water entry pressure relative to an IPA aqueous solution was 40 kPa, and the Gurley air permeability B₁ was 3 seconds/100 mL.

### (Original Porous PTFE Membrane D)

To a PTFE dispersion (concentration of PTFE powder: 40% by mass, average particle diameter of PTFE powder: 0.2 μm, nonionic surfactant contained in 100 parts by mass of PTFE: 6 parts by mass), namely to 100 parts by mass of PTFE, 1 part by mass of fluorine-based surfactant (MEGAFAC F-142D manufactured by DIC Corporation) was added. Next, a long polyimide film (thickness: 125 μm) was soaked in the PTFE dispersion and pulled up to form a coating of PTFE dispersion on the film. At this time, the thickness of the coating film was set to 20 μm using a measuring bar. Next, by heating the coating film at 100° C. for 1 minute and then at 390° C. for 1 minute, the water contained in the dispersion was evaporated and removed, and the remaining PTFE particles were bonded to each other, whereby a PTFE membrane was obtained. After repeating the above soaking and heating process two more times, the PTFE film (thickness: 25 μm) was peeled off from the polyimide film. Next, the peeled cast film was rolled in the MD direction (longitudinal direction) and further stretched in the TD direction (width direction). Rolling in the MD direction was performed by roll rolling. The rolling magnification (area magnification) was 2.0 times, and the temperature (roll temperature) was 170° C. Stretching in the TD direction was performed using a tenter stretching machine. The stretching ratio in the TD direction was 2.0 times, and the temperature (stretching atmosphere temperature) was 300° C. The thickness of the obtained original porous PTFE membrane D was 10 μm, the maximum pore diameter was 60 nm, the porosity was 30%, the water entry pressure relative to IPA aqueous solution was 200 kPa, and the Gurley air permeability B₁ was 75 seconds/100 mL.

### Examples 1 to 8

The original porous PTFE membrane A was used as the original porous fluorine resin membrane.

As an oil-repellent treatment liquid, a mixture of an oil-repellent agent α and a solvent was prepared. The oil-repellent agent α included a polymer whose monomer being a compound shown in Chemical Formula (a) below.

CH₂=C(CH₃)COOCH₂CH₂C₅F₁₀CH₂C₄F₉ (a)

The solvent was added so that the concentration of the oil-repellent agent α in the oil-repellent treatment liquid was 1.7% by weight (Examples 1 to 3), 3.7% by weight (Examples 4 to 6), or 7.1% by weight (Examples 7 and 8). The solvent was a mixed solution of 1,1,2,2-tetrafluoroethoxy-1-(2,2,2-trifluoro)ethane (hereinafter, referred to as HFE-347pc-f) (AE-3000 manufactured by AGC Inc.) and meta-xylene hexafluoride (hereinafter, referred to as MX-HF). The mixing ratio was expressed as a volume ratio and was set as HFE-347pc-f:MX-HF=3:1.

Next, the prepared oil-repellent treatment liquid was applied to one principal surface of the original porous PTFE membrane A. This was then dried at 60 to 70° C. As for application of the oil-repellent treatment liquid, the treatment was carried out by adjusting the discharge amount from the coating machine so that the wet thickness of the oil-repellent treatment liquid was 70 μm (Examples 1 and 4), 40 μm (Examples 2, 5, and 7), or 30 μm (Examples 3, 6, and 8). In this way, air-permeable filters of Examples 1 to 8 were obtained.

### Examples 9 to 11

The original porous PTFE membrane A was used as the original porous fluorine resin membrane.

As an oil-repellent treatment liquid, a mixture of oil-repellent agent β and a solvent was prepared. The oil-repellent agent β included a polymer whose monomer being the compound shown in Chemical Formula (b) below.

CH₂=CHCOOCH₂CH₂C₆F₁₃ (b)

The solvent was added so that the concentration of oil-repellent agent β in the oil-repellent treatment liquid was 3.7% by weight (Examples 9 and 10), or 4.8% by weight (Example 11). As for the solvent, the same solvent as in Examples 1-8 was used.

Next, the prepared oil-repellent treatment liquid was applied to one principal surface of the original porous PTFE membrane A. The treatment was carried out by adjusting the discharge amount from the coating machine so that the wet thickness of the oil-repellent treatment liquid was 70 μm (Example 9), 60 μm (Example 10), or 56 μm (Example 11). In this way, air-permeable filters of Examples 9 to 11 were obtained.

### Example 12

The original porous PTFE membrane B was used as the original porous fluorine resin membrane.

As an oil-repellent treatment liquid, a mixture of the oil-repellent agent α and a solvent was prepared. The solvent was added so that the concentration of the oil-repellent agent α in the oil-repellent treatment liquid was 1.0% by weight. As for the solvent, the same solvent as in Examples 1-8 was used.

Next, the prepared oil-repellent treatment liquid was applied to one principal surface of the original porous PTFE membrane B. The treatment was carried out by adjusting the discharge amount from the coating machine so that the wet thickness of the oil-repellent treatment liquid was 11 μm. In this way, an air-permeable filter of Example 12 was obtained.

### Example 13

The original porous PTFE membrane C was used as the original porous fluorine resin membrane.

As an oil-repellent treatment liquid, a mixture of the oil-repellent agent α and a solvent was prepared. The solvent was added so that the concentration of the oil-repellent agent α in the oil-repellent treatment liquid was 3.0% by weight. As for the solvent, the same solvent as in Examples 1-8 was used.

Next, the prepared oil-repellent treatment liquid was applied to one principal surface of the original porous PTFE membrane C. The treatment was carried out by adjusting the discharge amount from the coating machine so that the wet thickness of the oil-repellent treatment liquid was 33 μm. In this way, an air-permeable filter of Example 13 was obtained.

### Examples 14 and 15

The original porous PTFE membrane D was used as the original porous fluorine resin membrane.

In Example 14, a mixture of the oil-repellent agent α and a solvent was prepared as the oil-repellent treatment liquid. The solvent was added so that the concentration of the oil-repellent agent α in the oil-repellent treatment liquid was 1.0% by weight. As for the solvent, the same solvent as in Examples 1-8 was used.

In Example 15, a mixture of the oil-repellent agent β and a solvent was prepared as the oil-repellent treatment liquid. The solvent was added so that the concentration of the oil-repellent agent β in the oil-repellent treatment liquid was 1.0% by weight. As for the solvent, the same solvent as in Examples 1-8 was used.

Next, in Examples 14 and 15, the prepared oil-repellent treatment liquid was applied to one principal surface of the original porous PTFE membrane D. The treatment was carried out by adjusting the discharge amount from the coating machine so that the wet thickness of the oil-repellent treatment liquid was 17 μm. In this way, air-permeable filters of Examples 14 and 15 were obtained.

### Comparative Examples 1 and 2

The oil-repellent treatment liquid was applied so that the wet thickness of the oil-repellent treatment liquid was 81 μm (Comparative Example 1), or 60 μm (Comparative Example 2). Other than that, the same process as in Examples 7 and 8 was carried out to obtain the air-permeable filters of Comparative Examples 1 and 2.

### Example 16

The original porous PTFE membrane A was used as the original porous fluorine resin membrane.

As an oil-repellent treatment liquid, a mixture of an oil-repellent agent γ including perfluoropolyether having a repeating unit as shown in Chemical Formula (d) below and a solvent was prepared.

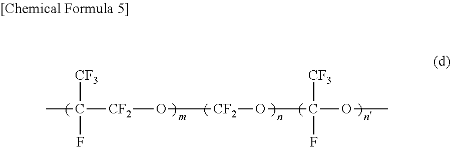

In Chemical Formula (d), the m:n:n′ ratio, expressed as m/n/n′ is 40/1/1, for instance.

The solvent was added so that the concentration of the oil-repellent agent γ in the oil-repellent treatment liquid was 10.0% by weight. As for the solvent, the same solvent as in Examples 1-8 was used.

Next, the prepared oil-repellent treatment liquid was applied to one principal surface of the original porous PTFE membrane A. The treatment was carried out by adjusting the discharge amount from the coating machine so that the wet thickness of the oil-repellent treatment liquid was 50 μm. In this way, an air-permeable filter of Example 16 was obtained.

### Comparative Example 3

The oil-repellent treatment liquid was applied so that the wet thickness of the oil-repellent treatment liquid was 80 μm. Other than that, the same process as in Example 16 was carried out to obtain the air-permeable filters of Comparative Example 3.

### Examples 17 and 18

The original porous PTFE membrane A was used as the original porous fluorine resin membrane.

As an oil-repellent treatment liquid, a mixture of an acrylate-based oil-repellent agent δ having perfluoropolyether as shown in Chemical Formula (g) below in its side chain and a solvent was prepared.

CH₂=CH₂COOCH₂CH₂NHCOCFCF₃—(OCF₂CF(CF₃))ₙ—OCF₂CF₂CF₃ (g)

In Chemical Formula (g), n is in a range of about 1 to about 12, with an average of about 6.

The solvent was added so that the concentration of the oil-repellent agent δ in the oil-repellent treatment liquid was 4.0% by weight. As for the solvent, the same solvent as in Examples 1-8 was used.

Next, the prepared oil-repellent treatment liquid was applied to one principal surface of the original porous PTFE membrane A. The treatment was carried out by adjusting the discharge amount from the coating machine so that the wet thickness of the oil-repellent treatment liquid was 54 μm in Example 17, or 72 μm in Example 18. In this way, air-permeable filters of Examples 17 and 18 were obtained.

### Examples 19 and 20

The original porous PTFE membrane A was used as the original porous fluorine resin membrane.

As an oil-repellent treatment liquid, a mixture of a methacrylate-based oil-repellent agent ε having perfluoropolyether in its side chain as shown in Chemical Formula (h) below and a solvent was prepared.

CH₂=CH(CH₃)COOCH₂CH₂NHCOCFCF₃—(OCF₂CF(CF₃))ₙ—OCF₂CF₂CF₃ (h)

In Chemical Formula (h), n is in a range of about 3 to about 8, with an average of about 6.

The solvent was added so that the concentration of the oil-repellent agent ε in the oil-repellent treatment liquid was 4.0% by weight. As for the solvent, the same solvent as in Examples 1-8 was used.

Next, the prepared oil-repellent treatment liquid was applied to one principal surface of the original porous PTFE membrane A. The treatment was carried out by adjusting the discharge amount from the coating machine so that the wet thickness of the oil-repellent treatment liquid was 54 μm in Example 19, or 72 μm in Example 20. In this way, air-permeable filters of Examples 19 and 20 were obtained.

The evaluation results for the air-permeable filters in the respective Examples and Comparative examples are shown in Table 1 and Table 2 below.

TABLE 1

| | Original porous fluorine resin membrane | | | Oil repellency conditions | | |
|---|---|---|---|---|---|---|
| | | Maximum | | | Oil-repellent | |
| | | pore | | Oil- | agent | Wet |
| | | diameter | Thickness | repellent | concentration | thickness |
| | Type | (nm) | (μm) | agent | (wt %) | (μm) |
| Example 1 | A | 120 | 50 | α | 1.7 | 70 |
| Example 2 | | | | | | 40 |
| Example 3 | | | | | | 30 |
| Example 4 | | | | | 3.7 | 70 |
| Example 5 | | | | | | 40 |
| Example 6 | | | | | | 30 |
| Comparative | | | | | 7.1 | 81 |
| Example1 | | | | | | |
| Comparative | | | | | | 60 |
| Example 2 | | | | | | |
| Example 7 | | | | | | 40 |
| Example 8 | | | | | | 30 |
| Example 9 | | | | β | 3.7 | 70 |
| Example 10 | | | | | | 60 |
| Example 11 | | | | | 4.8 | 56 |
| Example 12 | B | 150 | 5 | α | 1.0 | 11 |
| Example 13 | C | 700 | 5 | α | 3.0 | 33 |
| Example 14 | D | 60 | 10 | α | 1.0 | 17 |
| Example 15 | | | | β | | 17 |
| Example 16 | A | 120 | 50 | γ | 10.0 | 50 |
| Comparative | A | 120 | 50 | γ | 10.0 | 80 |
| Example 3 | | | | | | |

| | Properties | | | | | | | |
|---|---|---|---|---|---|---|---|---|
| | | | Rate of | | | | | |
| | | | difference in | | Gurley air | Air- | IPA water | |
| | | | absorbance | | permeability | permeability | entry | |
| | Absorbance | Absorbance | ratios | Oil | B₂ | decline rate | pressure | Porosity |
| | ratio R_{f} | ratio R_{b} | (%) | repellency | (s/100 mL) | (%) | (kPa) | (%) |
| Example 1 | 0.0184 | 0.0023 | 88 | C10× | 42 | 35.7 | 246 | 65.9 |
| Example 2 | 0.0140 | 0.0014 | 90 | C13 | 35 | 22.9 | 200 | 68.8 |
| Example 3 | 0.0100 | 0.0007 | 93 | C15 | 31 | 12.9 | 200 | 72.7 |
| Example 4 | 0.0232 | 0.0151 | 35 | C9 | 57 | 47.4 | 303 | 64.3 |
| Example 5 | 0.0157 | 0.0083 | 47 | C10Δ | 40 | 25.0 | 210 | 68.5 |
| Example 6 | 0.0164 | 0.0013 | 92 | C10Δ | 36 | 16.7 | 200 | 72.0 |
| Comparative | 0.0406 | 0.0412 | −1 | C7 | 325 | 91.4 | 503 | 55.1 |
| Example 1 | | | | | | | | |
| Comparative | 0.0344 | 0.0350 | −2 | C8 | 101 | 72.3 | 270 | 60.4 |
| Example 2 | | | | | | | | |
| Example 7 | 0.0281 | 0.0193 | 31 | C8 | 57 | 50.9 | 260 | 63.2 |
| Example 8 | 0.0279 | 0.0031 | 89 | C9 | 48 | 41.7 | 253 | 64.0 |
| Example 9 | 0.0320 | 0.0210 | 34 | C9 | 39 | 23.1 | 250 | 67.2 |
| Example 10 | 0.0340 | 0.0180 | 47 | CS | 42 | 28.6 | 250 | 66.3 |
| Example 11 | 0.0357 | 0.0337 | 6 | C9 | 40 | 25.0 | 250 | 68.2 |
| Example 12 | 0.0098 | 0.0076 | 22 | C13 | 1.7 | 17.6 | 180 | 76 |
| Example 13 | 0.0340 | 0.0320 | 6 | C7 | 9 | 66.7 | 70 | 75 |
| Example 14 | 0.0087 | 0.0018 | 79 | C13 | 131 | 47.5 | 350 | 33 |
| Example 15 | 0.0075 | 0.0038 | 49 | C14 | 99 | 10.4 | 350 | 28 |
| Example 16 | 0.0152 | 0.0106 | 30 | C13 | 41 | 31.8 | 240 | 65.4 |
| Comparative | 0.0280 | 0.0286 | −2 | C9 | 250 | 88.8 | 270 | 58.2 |
| Example 3 | | | | | | | | |

TABLE 2

| | Original porous fluorine | | | | | |
|---|---|---|---|---|---|---|
| | resin membrane | | | Oil repellency conditions | | |
| | | Maximum | | | Oil-repellent | |
| | | pore | | Oil- | agent | Wet |
| | | diameter | Thickness | repellent | concentration | thickness |
| | Type | (nm) | (μm) | agent | (wt %) | (μm) |
| Example 17 | A | 120 | 50 | δ | 4.0 | 54 |
| Example 18 | | | | | | 72 |
| Example 19 | | | | ε | 4.0 | 54 |
| Example 20 | | | | | | 72 |

| | Properties | | | | | | | |
|---|---|---|---|---|---|---|---|---|
| | | | Rate of | | | | | |
| | | | difference in | | Gurley air | Air | IPA water | |
| | | | absorbance | | permeability | permeability | entry | |
| | Absorbance | Absorbance | ratios | Oil | B₂ | decline rate | pressure | Porosity |
| | ratio R_{f} | ratio R_{b} | (%) | repellency | (s/100 mL) | (%) | (kPa) | (%) |
| Example 17 | 0.0945 | 0.0444 | 53 | C9 | 31 | 21 | 285 | 67.4 |
| Example 18 | 0.1025 | 0.0587 | 43 | C8 | 33 | 25 | 305 | 65.7 |
| Example 19 | 0.1163 | 0.0339 | 71 | C10 | 31 | 19 | 190 | 64.9 |
| Example 20 | 0.1301 | 0.0496 | 62 | C9 | 33 | 23 | 340 | 64.7 |

As shown in Tables 1 and 2, as for the air-permeable filter in Example, the absorbance ratio R_{f} of one principal surface and the absorbance ratio R_{b} of the other principal surface were not the same. As a result, the rate of difference in the absorbance ratios was a positive value, thereby exhibiting a sufficient oil repellency and preventing or reducing decline in the air permeability. The air-permeable filter in Comparative Example ensured a certain degree of oil repellency, but its air permeability declined significantly in comparison with the air permeability in Examples. This is thought to be due to an excess oil-repellent agent that clogged the pores of the porous PTFE membrane in Comparative Example. In this way, the air-permeable filter in Example exhibited oil repellency while preventing or reducing decline in air permeability, regardless of the pore diameter of the porous fluorine resin membrane.

The absorbance ratio of the one principal surface in Example 7 was almost the same as the absorbance ratio of the one principal surface in Example 9. However, the air permeability decline rate in Example 9 using the oil-repellent agent β was further reduced in comparison with the air permeability decline rate in Example 7 using the oil-repellent agent α. The absorbance ratio of the one principal surface in Example 14 was almost the same as the absorbance ratio of the one principal surface in Example 15. However, the air permeability decline rate in Example 15 using the oil-repellent agent R was further reduced in comparison with the air permeability decline rate in Example 14 using the oil-repellent agent α.

In Examples 1 to 12 and 14 to 20, the maximum pore diameters were relatively small while in Example 13, the maximum pore diameter was relatively large. Examples 1 to 12 and 14 to 20 exhibited higher oil repellency and smaller air permeability decline rate in comparison with Example 13. The maximum pore diameter of the porous fluorine resin membrane in Example 13 exceeded 500 nm, which was the same as before the oil-repellent treatment. Furthermore, in Examples 1 to 12 and 14 to 20, the maximum pore diameters after the oil-repellent treatment were kept to be 500 nm or less.

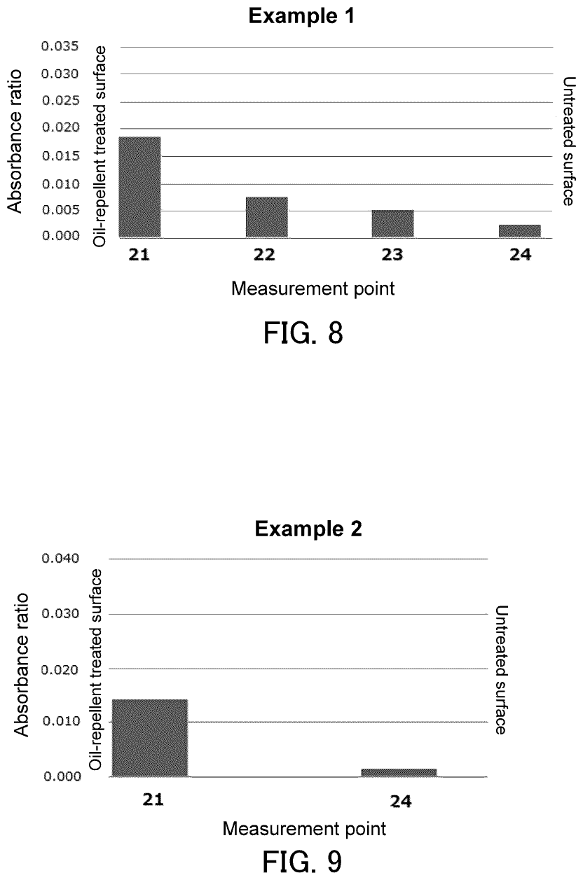

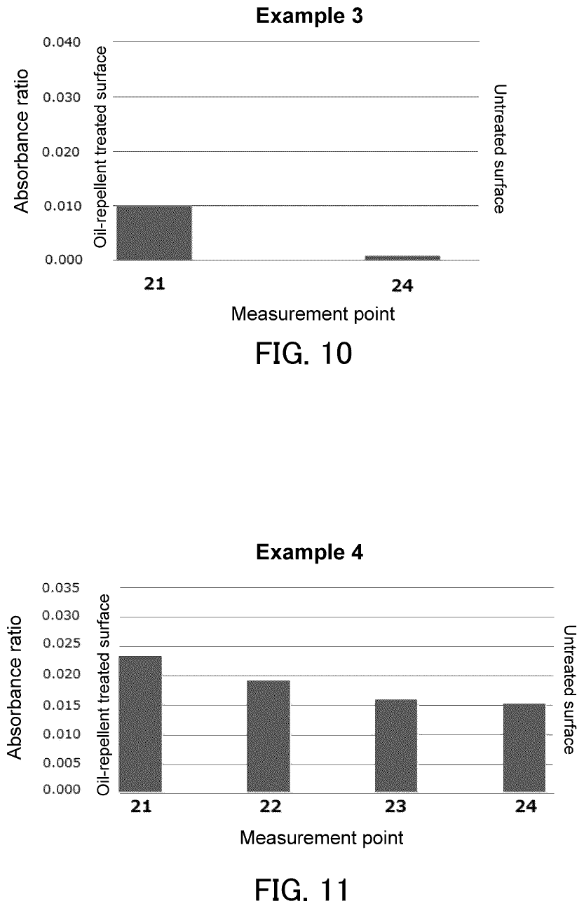

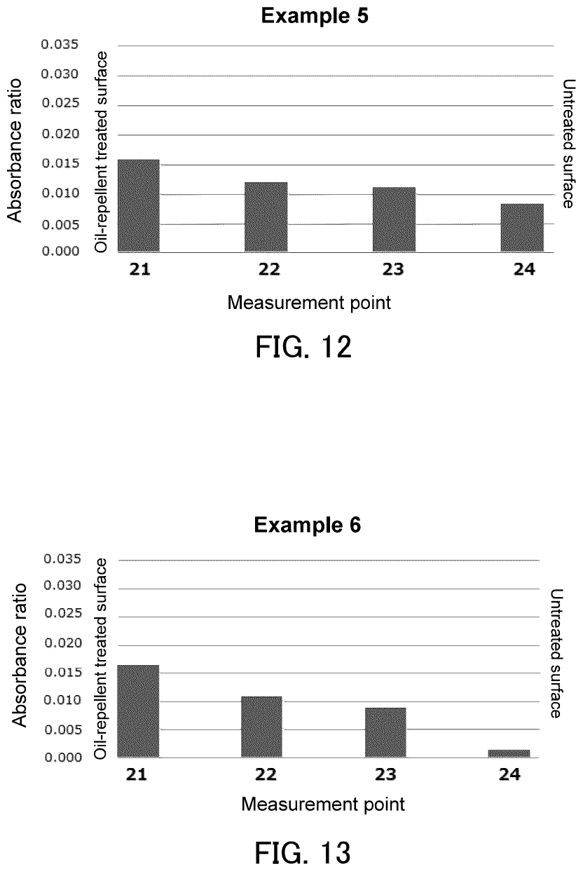

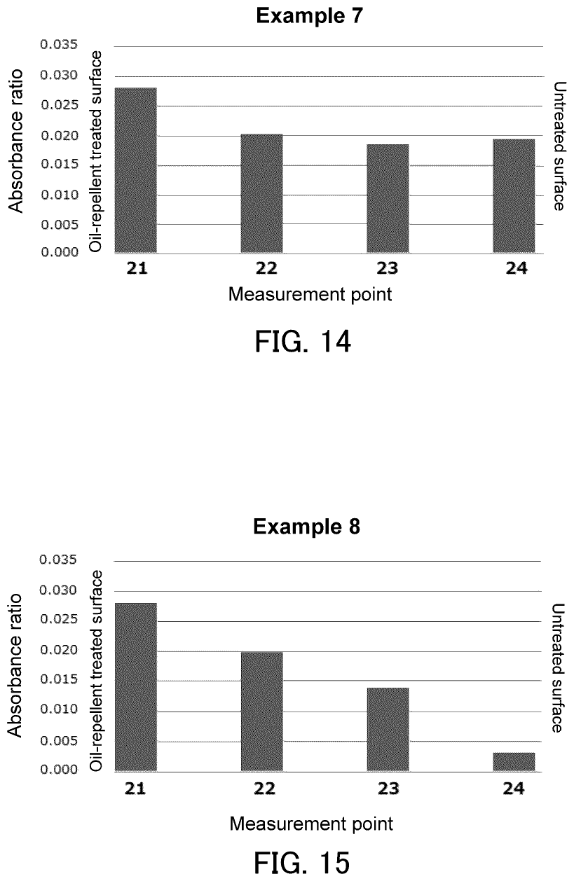

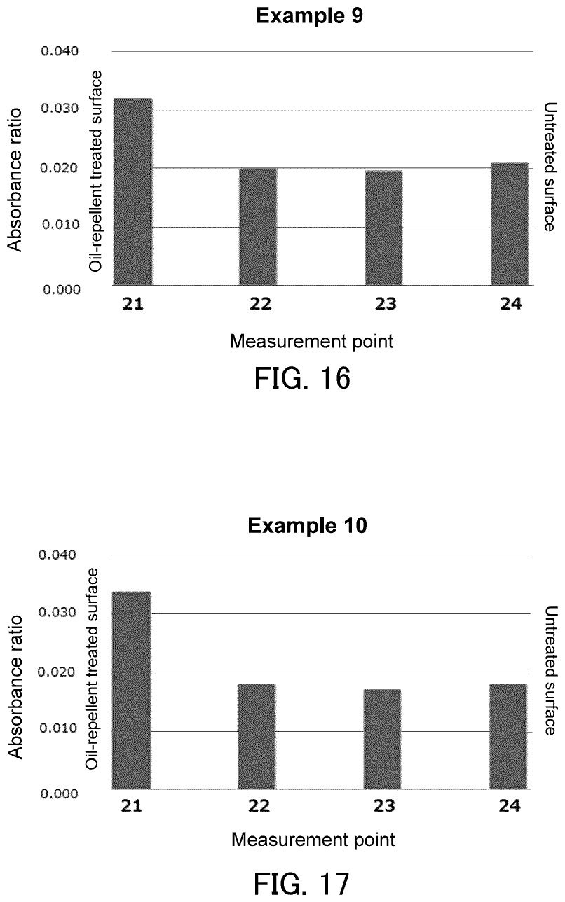

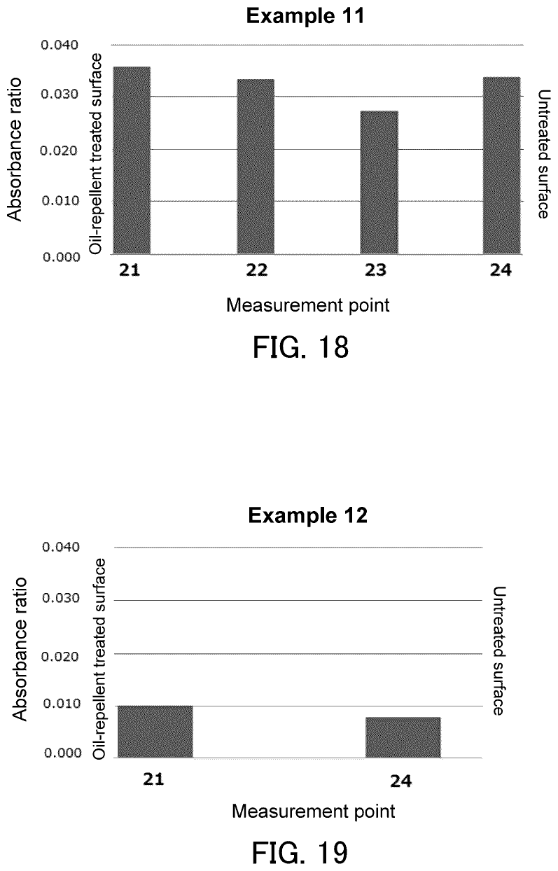

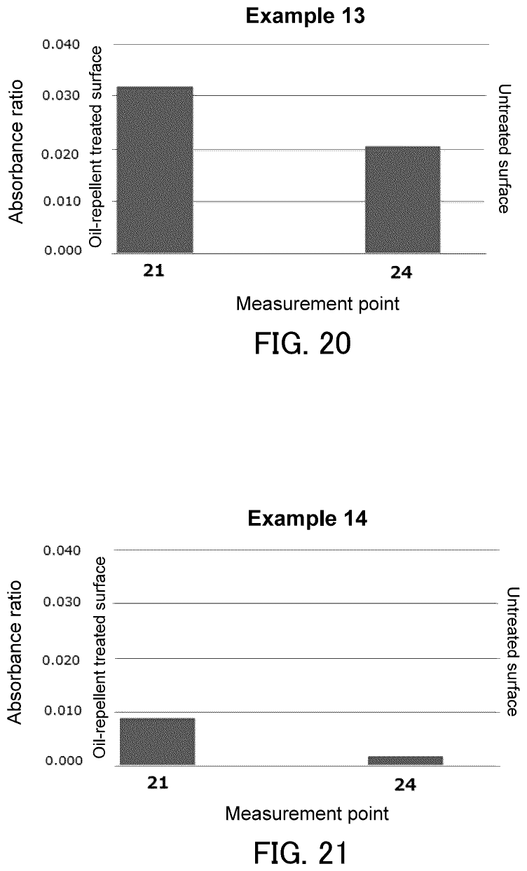

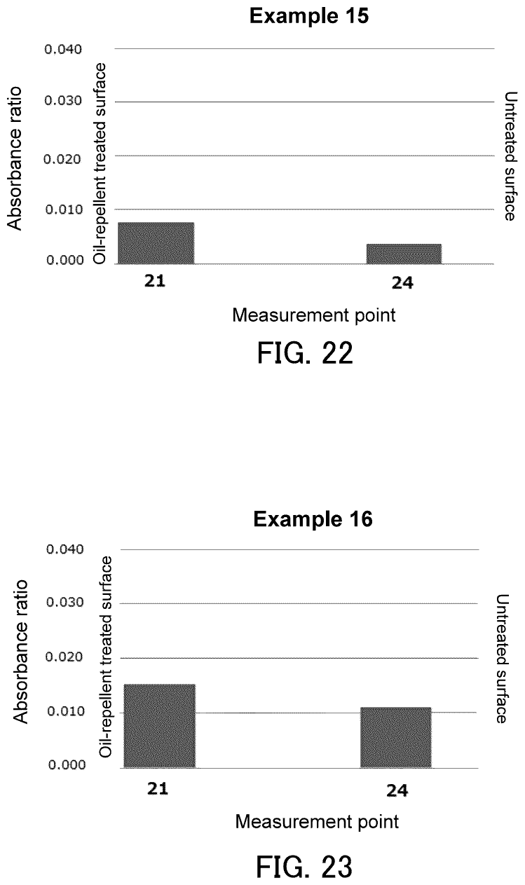

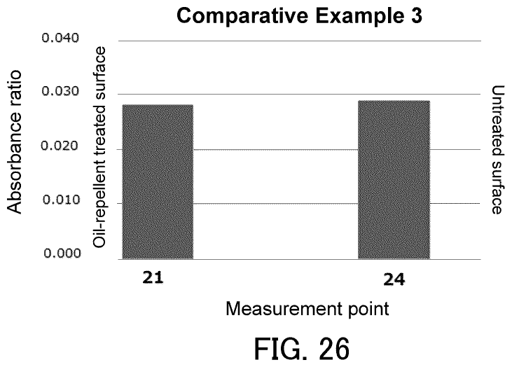

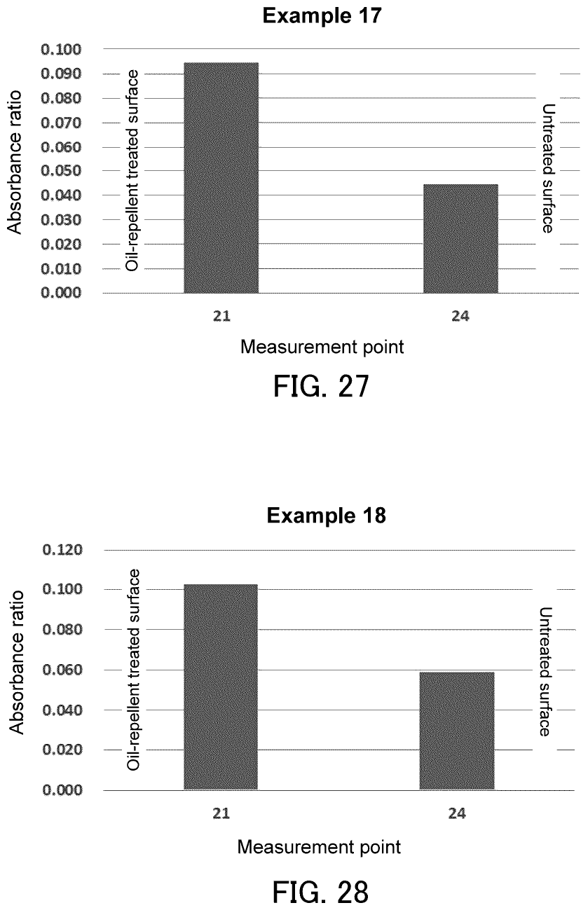

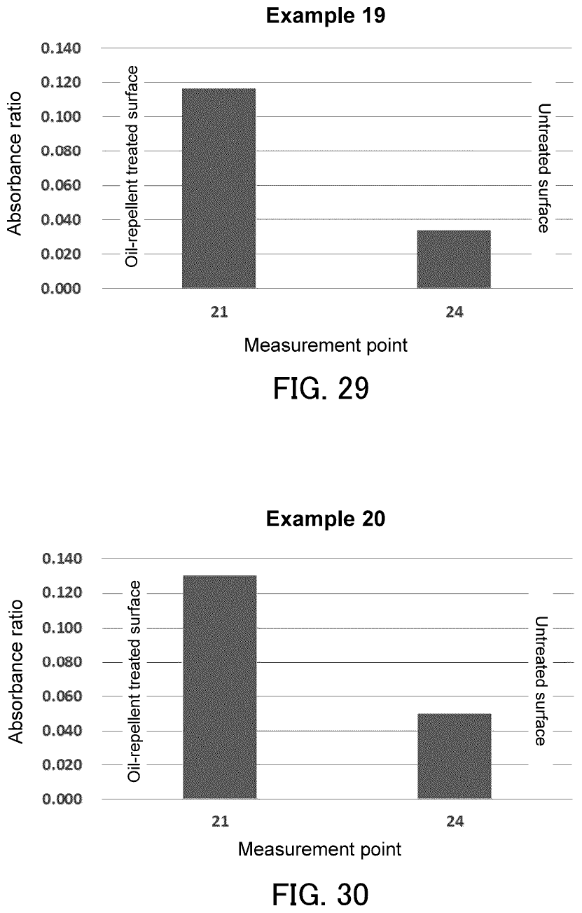

FIG. 8 to 30 are graphs showing absorbance ratios in the thickness direction of the air-permeable filters of Examples 1 to 16, Comparative Examples 1 to 3, and Examples 17 to 20. In FIG. 8 to 30, the horizontal axes correspond to the signs of the measurement points in FIG. 7A. In FIG. 8 to 30, the vertical axes correspond to the absorbance ratios calculated by Formula (1) above. In Comparative Examples 1 to 3, the slight difference between the absorbance ratio R_{f} and absorbance ratio R_{b} is in the range of 0.0015 or less, and more specifically 0.001 or less. Therefore, the absorbance ratio R_{f} and the absorbance ratio R_{b} are regarded as substantially the same.

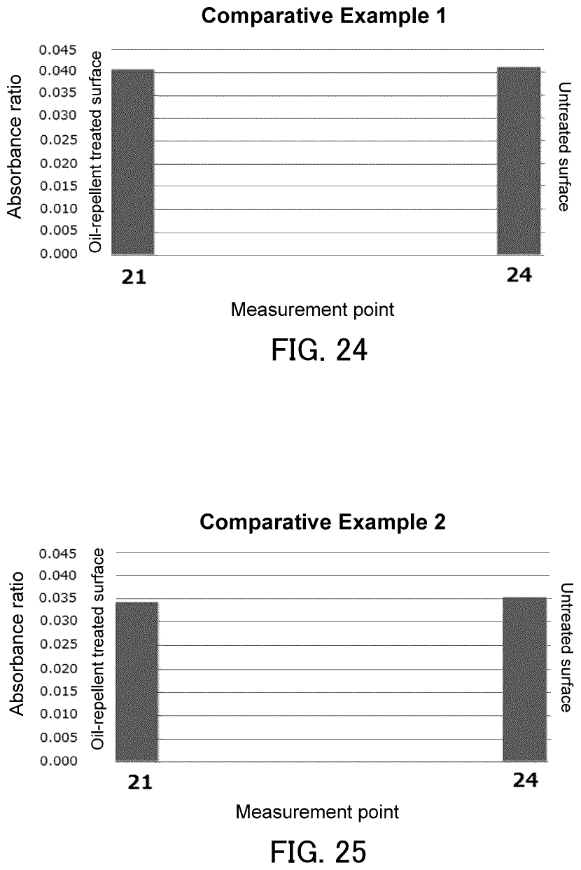

In each Example, R_{f}>0, R_{b}>0 and R_{f}>R_{b} were all satisfied. In Examples 1, 4 to 6 and 8, R_{f}>Rₘ>R_{b} was satisfied. As shown in FIG. 24 to 26, in Comparative Examples 1 to 3, an oil-repellent agent was supplied sufficiently to the porous PTFE membrane, and as a result, the same amount of oil-repellent agent was present on both principal surfaces of the porous PTFE membrane, and R_{f}>R_{b} was not satisfied. In Comparative Examples 1 to 3, it is assumed that the excess oil-repellent agent clogged the pores of the porous PTFE membranes, significantly declining the air permeability of the air-permeable filters.

In Examples 2 to 3 and 12 to 20, measurement of the Rₘ was impossible because it was difficult to cut through the porous fluorine resin membrane in a direction parallel to the one principal surface and the other principal surface. In Comparative Examples 1 to 3, measurement of the Rₘ was omitted. However, because the oil-repellent agent was distributed almost uniformly in the thickness direction, it was indicated that the same amount of oil-repellent agent was distributed from the one principal surface to the other principal surface.

Although measurements were omitted, the maximum pore diameters of the porous fluorine resin membranes after applying the oil-repellent agent are smaller than the maximum pore diameters of the original porous fluorine resin membranes.

### INDUSTRIAL APPLICABILITY

The technology disclosed in the present specification can be used for the purpose of imparting water resistance to electronic devices such as mobile phones, laptop computers, electronic notebooks, digital cameras, and gaming devices, though the application of the technology disclosed in this specification is not limited to electronic devices. The technology disclosed in this specification can be used for the purpose of imparting water resistance to housings of automotive parts like products without voice functions, such as sensors, switches, ECU, and power conditioning systems (FCPC).

1. An air-permeable filter comprising a porous fluorine resin membrane having one principal surface and the other principal surface, the porous fluorine resin membrane being treated with an oil-repellent agent, wherein
in a measurement of an absorption spectrum of the air-permeable filter by Fourier transform infrared spectroscopy, an absorbance ratio R_{f} of the one principal surface and an absorbance ratio R_{b} of the other principal surface calculated by Formula (1) below are not substantially the same:
$${A}_{a} / {A}_{m} \qquad Formula ( 1 )$$
where Aₐ indicates an absorbance at a peak derived from the oil-repellent agent in the absorption spectrum, and Aₘ indicates an absorbance at a peak derived from a C—F bond in the absorption spectrum.

2. The air-permeable filter according to claim 1, satisfying R_{f}>0 and R_{b}>0.

3. The air-permeable filter according to claim 1, satisfying R_{f}>R_{b}, and
the one principal surface has an oil repellency to prevent permeation of n-alkane having 15 carbon atoms.

4. The air-permeable filter according to claim 1, wherein
the porous fluorine resin membrane has a maximum pore diameter and a Gurley air permeability satisfying at least one of a) to c) below:
a) a maximum pore diameter of 75 nm or less, a Gurley air permeability of 160 seconds/100 mL or less;
b) a maximum pore diameter of 150 nm or less, a Gurley air permeability of 80 seconds/100 mL or less;
c) a maximum pore diameter of 900 nm or less, a Gurley air permeability of 12 seconds/100 mL or less.

5. The air-permeable filter according to claim 1, wherein
the porous fluorine resin membrane has a Gurley air permeability of 90 seconds/100 mL or less.

6. The air-permeable filter according to claim 1, wherein
a rate of difference between the absorbance ratio of the one principal surface and the absorbance ratio of the other principal surface calculated by Formula (2) below is 4% or more:
$$100 \times ( {R}_{f} - {R}_{b} ) / {R}_{f} . \qquad Formula ( 2 )$$

7. The air-permeable filter according to claim 1, satisfying R_{f}>Rₘ>R_{b},
where Rₘ is an absorbance ratio at a depth of 40 to 60% of the porous fluorine resin membrane in a thickness direction of the porous fluorine resin membrane from the one principal surface.

8. The air-permeable filter according to claim 1, wherein
the porous fluorine resin membrane is a porous polytetrafluoroethylene membrane.

9. The air-permeable filter according to claim 1, wherein
the oil-repellent agent comprises a fluorine-containing polymer.

10. The air-permeable filter according to claim 9, wherein
the fluorine-containing polymer comprises a polymer whose monomer is a compound represented by CH₂═CR¹COOR²,
where R¹ is either a hydrogen atom or a methyl group, and R² is a hydrocarbon group in which at least one hydrogen atom is substituted by a fluorine atom.

11. The air-permeable filter according to claim 9, wherein
the fluorine-containing polymer comprises perfluoropolyether.

12. The air-permeable filter according to claim 1, wherein
the one principal surface of the porous fluorine resin membrane has a water entry pressure of 180 kPa or more to an aqueous isopropanol solution with a concentration of 30% by weight.

13. The air-permeable filter according to claim 1, wherein
the porous fluorine resin membrane has a porosity of 63% or more.

14. The air-permeable filter according to claim 1, wherein
the porous fluorine resin membrane has a maximum pore diameter of 500 nm or less.

15. The air-permeable filter according to claim 1, further comprising a support layer for supporting the porous fluorine resin membrane.

16. An air-permeable member comprising:
the air-permeable filter according to claim 1; and
a pressure-sensitive adhesive layer bonded to the air-permeable filter.
